(19) United States
(12) Patent Application Publication
(10) Pub. No.: US 2002/0034964 A1
(43) Pub. Date: Mar. 21, 2002

(54) Personal information terminal equipped with enlarging optical system

(76) Inventors: Yuichi Bannai, Tokyo (JP); Takahiro Kurosawa, Tokyo (JP); Takashi Oya, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/944,070

(22) Filed: Sep. 4, 2001

(30) Foreign Application Priority Data
Sep. 5, 2000 (JP) 268545/2000
Sep. 12, 2000 (JP) 277340/2000
Feb. 26, 2001 (JP) 2001/050349

(51) Int. Cl. H04M 1/00

(52) U.S. Cl. 455/556; 455/566; 455/66

(57) ABSTRACT

There is provided a personal information terminal being compact in size but capable of large-screen display of information, and being made so that the terminal's energy consumption is reduced and the terminal is capable of being carried around. The terminal has a data display device equipped with an enlarging optical system, an input device for receiving instructions from a user, a radio communications device for connecting to a network, and a control device for obtaining information from the network through the radio device and making the information be displayed on the data display device based on instructions from the input device, and additionally, while the control device is obtaining the information from the network through the radio device the control device turns off an electrical power supply to a backlight which comprises the data display device.

### BACKGROUND OF THE INVENTION

1. Field of the Invention

The present invention pertains to a personal information terminal, and particularly to an energy consumption reduction method to be applied in a personal information terminal equipped with an ocular-type screen display device.

2. Related Background Art

In recent years, as optical design and production technology, liquid crystal display technology, semiconductor manufacturing technology, semiconductor design technology, communications technology, mounting technology and the like have developed and advanced, technology and products such as those described below have come to be produced.

(Optical Devices)

As optical design and manufacturing technology has developed, enlarged projection using free-form surface prisms has become a reality, and thus it has become possible for a small-size optical device to offer a large screen. Further, by combining such an optical device together with a high-definition display device such as a micro-display, it becomes possible to obtain a broad-field and high-resolution display which is still small in size. Technology such as this has been applied in Head Mounted Displays (HMDs), or displays which are mounted on a user's head, for example. An example of this is GT-270 produced by Canon, Inc.

Additionally, there is a patent belonging to Canon, Inc. (Japanese Patent Application Laid-Open No. 9-179062, “Computer System”; ATEYAMA) which is a computer system integrating a High-definition display devices (HMD) with a CPU.

As liquid crystal display (LCD) technology has developed, small but high-definition displays have become possible. Particularly, with Liquid Crystal on Silicon (LCoS) technology, in which liquid crystal materials are placed on a CMOS backplate, high density circuitry production technology used in semiconductor manufacturing is applied to achieve high resolution and high reaction speed. An example of this is the micro-display CMD 8×6 series produced by CMD, Inc. (USA)

(Input Devices Using Impact Elements, etc.)

By using of impact elements or similar techniques, slight movements of the finger can be detected, and this has led to the diffusion of input devices which work by pointing and clicking a button within a two-dimensional plane corresponding to a mouse. This type of input device is used as an embedded button and an assisting button for mouse scrolling used in a note-type Personal Computer (PC).

(Reduced-size Computer Devices)

With the development of semiconductor manufacturing technology and semiconductor design technology, it has become possible to realize computer devices which have high processing capability despite being small and energy-efficient. Further, processors have come into circulation in which the functions which comprise the computer device, such as the bus control, the memory control and a timer, for example, are incorporated onto a single chip.

Furthermore, due to the arrival of a technology called System on a Chip (SoC) or the like, it has become possible to realize on a single chip the functions which previously were comprised by combining a plurality of semiconductor chips including the ASIC unit. As a result, not only is it possible for the volume to be compact, but also the energy consumption can be reduced. The ARM Core by ARM, Inc. (UK) is a known example of an SoC processor core.

(Wide Area Wireless Communications Networks)

As wide area wireless communications networks such as Personal Handy phone Systems (PHS) and portable telephones have been set up and portable telephone terminals have diffused explosively, it has become possible to conduct network communications without being limited by spatial restrictions. Additionally, with the introduction of IMT-2000 specifications, communications band width has grown in leaps and bounds.

Further, with NTT DoCoMo, Inc.'s i-mode service and with Japan Mobile Communications, INC.'s EZ Access, for example, although there are a number of limitations it is possible to access internet information services via their wide area wireless communications networks.

(Portable Telephone Terminals)

Due to advances in mounting and other technologies in recent years, dramatic size reduction has been achieved in terminals for connecting to the portable telephone network, that is a wide area wireless communications networks provided by NTT Docomo, Inc. and other companies. Further, although there are a number of limitations, the portable telephone terminals which are used for NTT Docomo's i-mode service and Japan Mobile Communications, Inc.'s EZ Access or the like enable use of internet information services.

Additionally, these portable telephone terminals are provided with functions for playing individually configured melodies when a communication arrives. This function is called the “arrival melody”. These melodies which are played by the arrival melody function are not limited single-note melodies, since portable telephone terminals now exist which are capable of harmony.

(Low-energy Consumption Wireless Communications Formats)

With the advance of technologies relating to communications frequency control circuits and field strength adjustment functions, for example, communications formats have been achieved which are capable of high speed communication despite low energy consumption. These sorts of communications formats are more frequently being used in many information instruments such as portable telephone terminals and note-type Personal Computers (PCs).

A representative example of this type of low-energy consumption wireless communications format is Bluetooth. Particularly, with the Bluetooth Special Interest Group (SIG), in order to diffuse and propel the use of Bluetooth, the protocol stack combinations are defined in a separate profile for each software application which utilizes data communications, in order to ensure the compatibility among Bluetooth-conformant devices. For example, the “Dial-up Networking profile” included in the Bluetooth specifications defines the communications protocol and communications sequences used in the case when a portable telephone terminal or such is used as an internet bridge.

(External Memory Devices)

Due to the advance of semiconductor manufacturing technologies and memory circuit formats, the storage capacity of memory devices has achieved dramatic progress. Particularly, in recent years it has become possible to use standardized external memory devices with any of various types of information instruments, and it has become possible to exchange vast amounts of information easily via these external memory devices. Examples include MMC cards introduced by the Multi-Media Card Association and Compact Flash cards produced by SanDisk, Inc.

(Personal Information Terminals)

Small-size, portable computers generally called a Personal Digital Assistants (PDAs) having schedule functions, memo notepad functions and telephone number notebook functions are used. PDAs are frequently equipped with smaller and lower resolution display devices than those used in the standard PC. A representative example of a PDA is Zaurus by Sharp, Inc. and the Palm by Palm, Inc. (USA).

(Internet Information Services)

It has become possible to obtain many kinds of complex information through the internet. Image, text, audio and other information are included in this information which can be circulated by a description format called Hyper Text Markup Language (HTML). Further, a connection provider called an Internet Service Provider (ISP) facilitates connection to the internet through wide area communications networks such as telephone networks, etc. As this type of internet information service becomes available over wide area communications networks spread around the entire world, massive amounts of information are now provided to end terminals in real time.

Also, NTT Docomo, Inc.'s i-mode uses a subset of HTML called Compact HTML to enable portable telephone terminals, which have more hardware limitations than PCs and the like, to make use of internet information services.

(Compact High-capacity Batteries)

With the appearance of lithium ion batteries and lithium polymer batteries, it has become possible to use high power density batteries, meaning that they are small but have large capacity. As a result, it has become possible to use portable apparatuses over long periods of time.

However, in the conventional HMD described above, in order for the user to wear the HMD and conduct interactions with the system it was necessary to have a special input device such as a data glove, and large amounts of electricity were needed in order to achieve sufficient brightness in the display screen, so there was the problem that it was difficult to carry the HMD outdoors and use it there.

Further, personal information terminals are suited for outdoor use and the like, but since there are limitations on the size of the terminal itself, it was not possible to make the display device large, and it was not possible to display a screen which is as large as the display used in a desktop personal computer (i.e., PC).

Further, in common ocular-type screen display devices there was an inconvenience that the user had to peer into the display device in order to know the operating status and communications status of the personal information terminal.

Further, in the conventional portable terminal device mentioned above, size reduction and portability have been pushed forward, with the result that it has become difficult to employ a large display screen device. Particularly, there is a problem that it is difficult to provide to the user in an appropriate fashion information which is provided from an external interface having increasingly high capacity, such as massive amounts of complex information available with internet information services, or from high quality image data available with images using high-definition digital photographs or computer graphics images (CGI), for example.

### SUMMARY OF THE INVENTION

The present invention was developed to solve problems such as those described above, and an objective of the present invention is to provide a personal information terminal which achieves being compact in size but capable of large-screen display of information, and being made so that the terminal's power consumption is reduced and the terminal is capable of being carried around.

Further, another object is to provide a personal information terminal which achieves convenient use for a user such that the user can know an operating state and communication state thereof without having to peer into a screen display device.

Additionally, an objective is to provide a personal information terminal which is capable of appropriately providing to the user such things as “massive amounts of complex information available with internet information services”, or “high quality image information available with images using high-definition digital photographs or CGI”.

In order to achieve the above objectives, the personal information terminal of the present invention comprises a data display means equipped with an enlarging optical system; an input means for receiving instructions from a user; a radio communications means for connecting to a network; and a control means for obtaining information from the network through the radio means and making the information be displayed on the data display means, based on instructions from the input means.

Further, the personal information terminal of the present invention comprises an ocular-type data display means lodged within a frame of a window and having an enlarging optical system; an input means for receiving instructions from a user; a radio communications means for connecting to a network; a control means for obtaining information from the network through the radio means and making the information be displayed on the data display means, based on instructions from the input means; and a notifying means arranged outside the frame of the window, for providing a notification to a user at least as to whether the control means is in a state of obtaining information from the network through the radio means or not.

Additionally, an energy-consumption reduction method of the present invention is an energy-consumption reduction method to be applied in a personal information terminal having a data display means equipped with an enlarging optical system, an input means for receiving instructions from a user and a radio communications means for connecting to a network, the method comprising the following steps: an information obtaining step in which information is obtained from the network through the radio means based on instructions from the input means; a display step in which the information obtained by the information obtaining step is made to be displayed on the data display means; and a limiting step in which while the information is being obtained from the network through the radio means at the information obtaining step, the electrical power supply to the data display means is limited to an amount which is less than an amount at a normal time.

Further, a status notification method of the present invention is a status notification method to be applied in a personal information terminal having an ocular-type data display means lodged within a frame of a window and having an enlarging optical system, an input means for receiving instructions from a user, a radio communications means for connecting to a network and a notifying means arranged outside the frame of the window, the method comprising the following steps: an information obtaining step in which information is obtained from the network through the radio means and making the information be displayed on the data display means, based on instructions from the input means; a display step in which the information obtained by the information obtaining step is made to be displayed on the data display means; and a notifying step in which a notification means provides a notification to a user at least as to whether the control means is in a state of obtaining information from the network through the radio means or not.

### BRIEF DESCRIPTION OF THE DRAWINGS

FIGS. 1A, 1B and 1C are external views of a personal information terminal equipped with an ocular-type display device according to the present invention;

FIG. 2 is a cross-sectional view depicting an interior arrangement of the personal information terminal;

FIG. 3 is a diagram depicting an optical path of an enlarging optical system;

FIG. 4 is a block diagram depicting a construction of the personal information terminal;

FIG. 5 is a diagram depicting a communications network used in the personal information terminal;

FIG. 6 is a flow chart depicting a sequence of processes of an operations program in the personal information terminal which is executed by a CPU;

FIG. 7 is a diagram depicting an initial screen displayed by a liquid crystal display device;

FIG. 8 is a flow chart depicting a sequence of processes for displaying content indicated by a URL;

FIG. 9 is a sequence chart depicting one typical example of forwarding information by HTTP;

FIG. 10 is a block diagram depicting a construction in which a VRAM has been added to the construction of the personal information terminal depicted in FIG. 4;

FIGS. 11A, 11B and 11C are external views depicting a second embodiment of a personal information terminal equipped with an ocular-type display device according to the present invention;

FIG. 12 a cross-sectional view from the front of the personal information terminal according to the second embodiment;

FIG. 13 is a block diagram depicting a construction of the personal information terminal according to the second embodiment;

FIG. 14 is a flow chart depicting a sequence of processes of an operations program in the personal information terminal and which is executed by a CPU, according to the second embodiment;

FIG. 15 is a flow chart depicting details of an initialization process at a step S1001 in FIG. 14;

FIG. 16 is a flow chart depicting a sequence of processes for displaying content indicated by a URL, according to the second embodiment;

FIG. 17 is a flow chart depicting a sequence of processes of an operations program in the personal information terminal which is executed by a CPU, according to a third embodiment;

FIG. 18 is a flow chart depicting a sequence of processes for displaying content indicated by a URL, according to a third embodiment;

FIGS. 19A and 19B are diagrams depicting one example of a response commands according to HTTP protocol;

FIG. 20 is a block diagram of a construction in which a VRAM has been added to the construction of the personal information terminal depicted in FIG. 13;

FIGS. 21A and 21B are external views depicting a fourth embodiment of a personal information terminal equipped with an ocular-type display device according to the present invention;

FIGS. 22A and 22B are diagrams depicting the personal information terminal of the present invention as it is gripped in a user's hand;

FIG. 23 is diagram depicting the user having brought the personal information terminal to his eye, peering into it and operating it;

FIG. 24 is a block diagram depicting a way of electronically constructing the personal information terminal, according to the fourth embodiment;

FIG. 25 is a transparent view from the front, depicting an internal construction of the personal information terminal;

FIG. 26 is a transparent view from the side, depicting an internal construction of the personal information terminal;

FIG. 27 is an external view of a fifth embodiment of a personal information terminal equipped with an ocular-type display device according to the present invention;

FIG. 28 is a flow chart depicting setting functions of the personal information terminal according to the first embodiment of the present invention;

FIG. 29 is an explanatory diagram depicting an example display of the setting functions of the personal information terminal according to the first embodiment of the present invention;

FIG. 30 is an explanatory diagram depicting how a personal information terminal according to a sixth embodiment of the present invention or the like is connected to a network;

FIG. 31 is an explanatory diagram depicting a typical display example in the personal information terminal according to the sixth embodiment of the present invention;

FIG. 32 is a flow chart depicting processing for displaying an image taken by a digital camera onto the personal information terminal according to the sixth embodiment of the present invention; and

FIG. 33 is a flow chart depicting processing for manipulating the digital camera in the personal information terminal according to the sixth embodiment of the present invention.

### DESCRIPTION OF THE PREFERRED EMBODIMENTS

Hereinafter, explanation will be made of embodiments of the present invention, making reference to the drawings.

(First Embodiment)

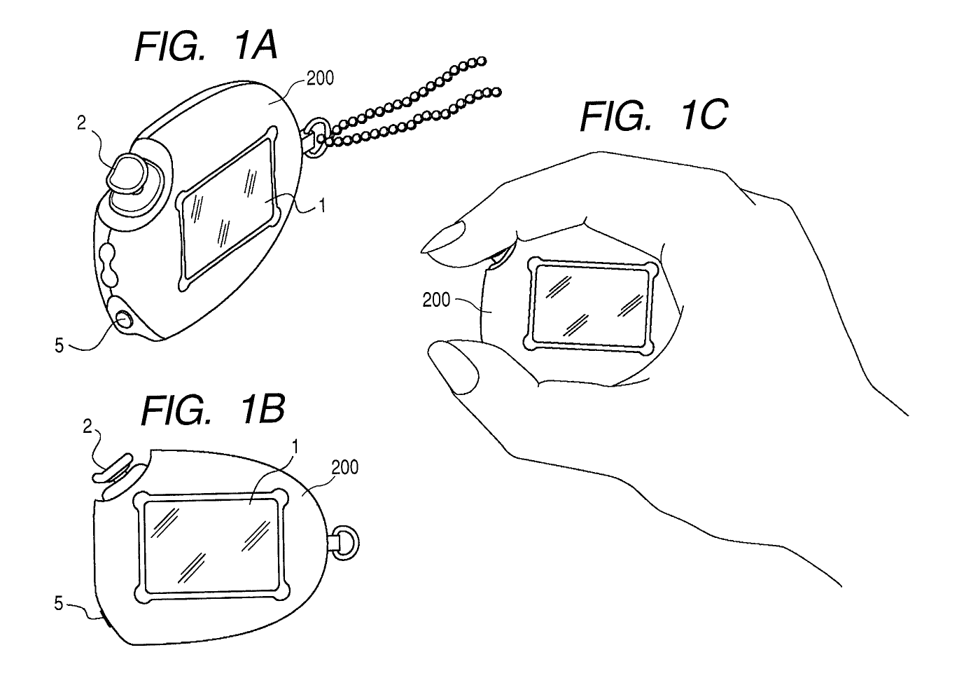

FIGS. 1A to 1C are external views of a personal information terminal 200 equipped with an ocular-type display device according to the present invention. FIG. 1A is a perspective view of the personal information terminal 200, FIG. 1B is a frontal view thereof, and FIG. 1C is a view depicting the personal information terminal 200 as it is gripped in a user's hand.

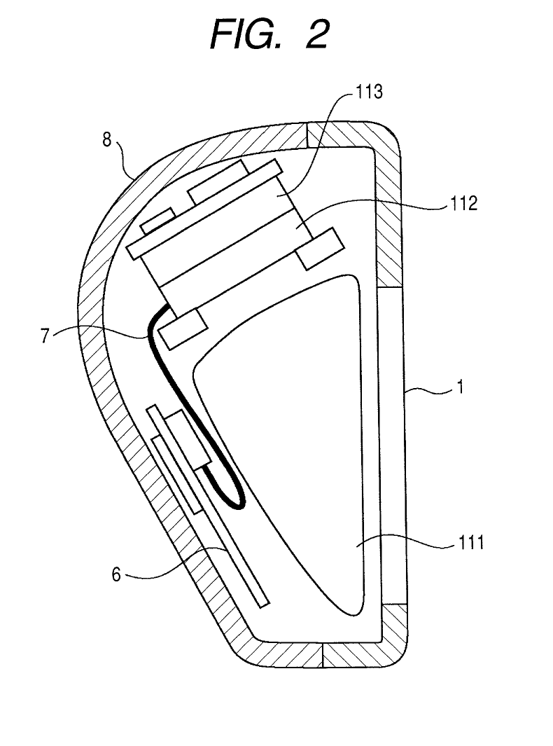

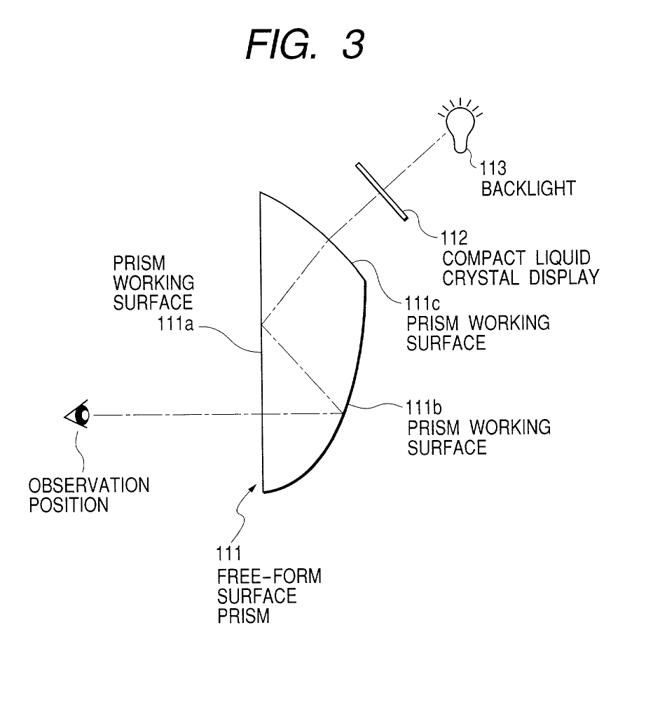

In the frontal view of the personal information terminal 200, there is a window 1 as shown in FIGS. 1A and 1B, and this window 1 is positioned on a side of a free-form surface prism 111 shown in FIG. 2 and FIG. 3 and described below, on a side of this prism 111 which is to be held up to the user's eye. The user grips the terminal in hand, brings his eye close to the window 1 and peers inside, producing the effect that the user views a screen of a liquid crystal display device (LCD) 112 described below in an enlarged fashion. The terminal uses a battery as its power source and has a radio communication function, so that the user may carry the terminal around and view necessary information.

As depicted in FIGS. 1A to 1C, there is a power button 5 on the bottom-left when viewed from the front, and an operating button 2 on the upper-right. The user manipulates the operating button 2 to obtain desired information.

FIG. 2 is a cross-sectional view depicting an interior arrangement of the personal information terminal 200.

The reference numeral 112 in the figure indicates a liquid crystal display device (i.e., LCD) having a plurality of pixels for displaying the information; 113 is a backlight for providing transmitted light to the liquid crystal display device 112; and 111 is a freeform surface prism 111 for enlarging the screen image of the liquid crystal display device 112. This liquid crystal display device 112, backlight 113 and free-form surface prism 111 comprise an enlarging optical system 11.

Further, reference numeral 6 indicates a main substrate for sending a driving signal to the liquid crystal display device 112; reference numeral 7 is a thread material tying the main substrate 6 and the liquid crystal display device 112 to each other; and reference numeral 8 is a housing for the personal information terminal.

FIG. 3 is a diagram depicting an optical path of the enlarging optical system 11. As shown in the diagram, in this embodiment there are three optical functions in the free-form surface prism 111. In the vicinity of the function 111c which is farthest from the observer there is arranged the compact liquid crystal display 112 and the backlight 113 which make up the display device, and these are adjusted so as to provide an optimal display to the observer. The working surfaces are each configured so that light emitted from the backlight 113 transmits through the compact liquid crystal display 112 via working surfaces 111c, 111a and 111b and arrives at the observer. By using the free-form surface prism the enlarging optical system for enlarging the output from the display device can be realized in a compact size.

In order to simplify the explanation transmission-type liquid crystal display elements have been used for the compact liquid crystal display 112; however, even in the case when reflection-type liquid crystal display elements are used it is possible to adjust the shape of the free-form surface prism and the position of the backlight or make other similar adjustments as is appropriate for the construction.

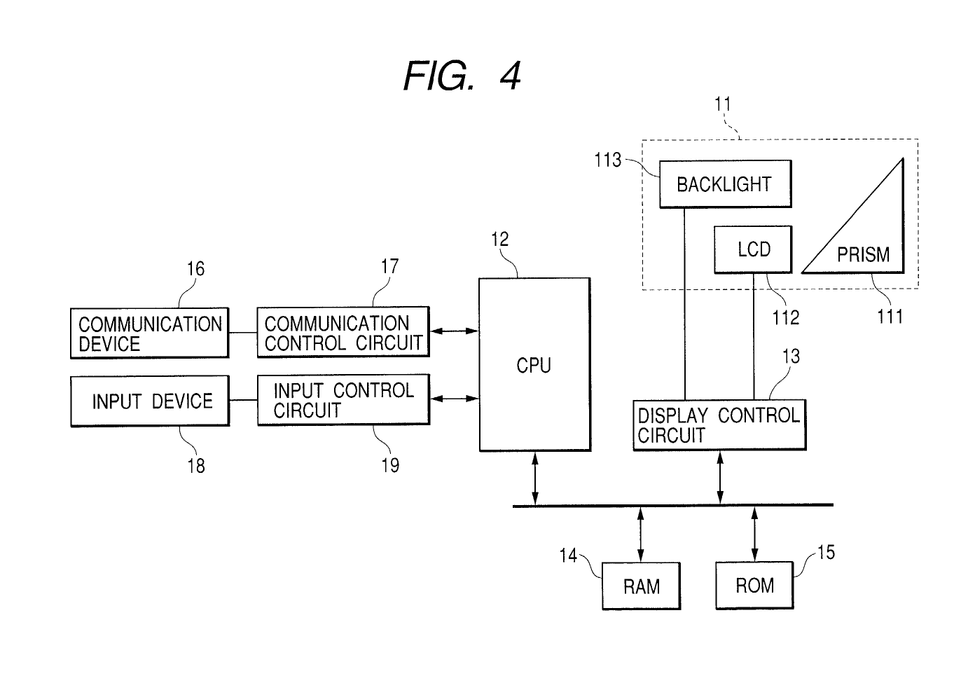

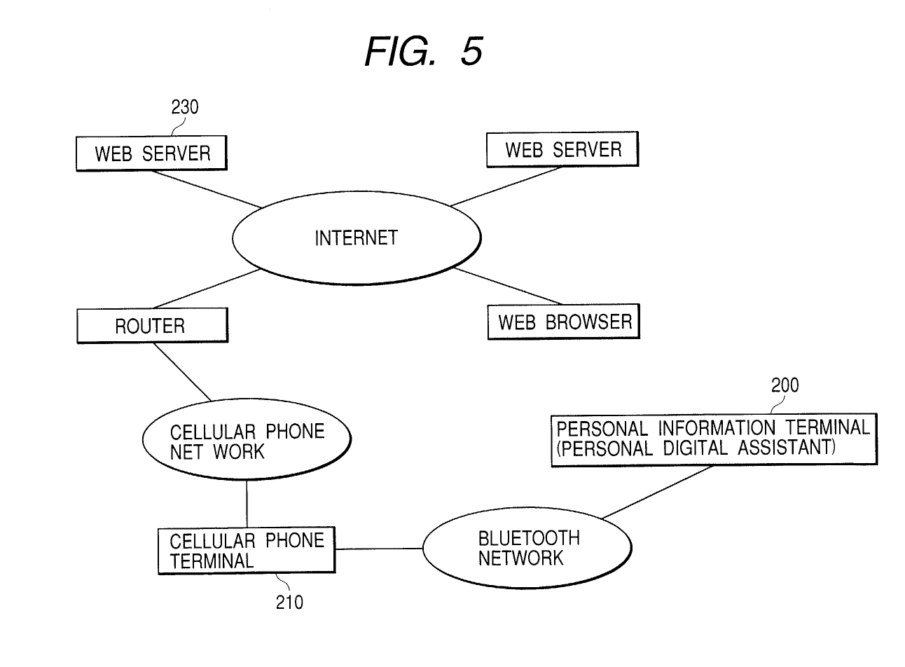

FIG. 4 is a block diagram depicting a construction of the personal information terminal.

A liquid crystal display device 112 has already been developed which is 1 inch or less in size and has 24-bit full color with 800×600 pixel resolution, known as Super Video Graphics Array (SVGA). This is used here. In the present embodiment the transmission-type LCD has been used, so the backlight 113 is arranged on the backside of the liquid crystal display device 112 on the opposite side from the observer.

The free-form surface prism 111 is a wedge-shaped free-form surface prism, and the light emitted from the liquid crystal display device 112 follows an optical path as indicated by the dashed line in FIG. 3, and an enlarged image of the liquid crystal display device 112 can be seen at the position of the observer. The following detailed explanation of the enlarging optical system 11 is disclosed in Japanese Patent Application Laid-Open No. 2000-10502 and others, so it is omitted here. This enlarging optical system 11 enables a construction of a size such that it is possible to grip and perform the manipulations with one hand as shown in FIGS. 1A to 1C, while also being capable of achieving a pseudo-large-screen display.

Reference numeral 12 indicates a central processing unit (CPU) for performing operation control on the entire unit, and reference numeral 13 is a display control circuit for performing control on the enlarging optical system 11. Reference numeral 14 is random access memory (RAM) for temporarily storing a portion of a program, data, etc., and reference numeral 15 is a read only memory (ROM) for storing a program described below for operation control and storing system information. Reference numeral 16 is a communications device for sending and receiving data between this terminal and external apparatuses; and reference numeral 17 is a communications control circuit for controlling the communications device 16 from the CPU 12. The communications device 16 is for performing communications with an external device, and is composed as an external memory device, a Bluetooth-conformant wireless communications device or cable communications device. In the case of a cable communications device there are instances in which the display image data supply and the power supply through the cable communications device are integrated together as one.

Here, explanation will now be made of internet communications performed by the personal information terminal, making reference to FIG. 5.

FIG. 5 is a diagram depicting a communications network used in the personal information terminal of the present embodiment.

On the internet and other such networks there are a plurality of web servers 230. The personal information terminal 200 uses a cellular phone terminal 210 and short-distance radio communications format Bluetooth to perform the communications. The communications format Bluetooth is a communications format which uses a 2.4 GHz frequency band and performs wireless communications across a distance of approximately 10 m at a data transmission speed of 1 Mbps.

The cellular phone line network is actually composed of a plurality of radio transmission base stations and switchboard facilities; however, in order to make the explanation simpler the explanation of the cellular phone line network is abbreviated here. The convergence of the cellular phone line network into the network is intermediated by a router. The router is often operated by the Internet Service Provider (ISP), and performs a role as a bridge between the cellular phone line network and the network.

A request from the cellular phone terminal 210 for the information of a published web page is sent to the connected web server 230, and when this is received the web server information is sent from the web server 230 back to the personal information terminal 200. Additionally, at the personal information terminal 200 the web page information which has been received is then analyzed and displayed. Note that in Bluetooth communications which run from the personal information terminal 200 to the cellular phone terminal 210, the communication is performed in accordance with a dial-up networking profile.

Further, a plurality of web browsers are connected onto the network, connecting to the web server 230 in a similar fashion to display the page information that is saved there. Further, the web server 230 is a server which is equipped with web technologies which are broadly diffused, the web browser is equipped in this way as well, and the page information which is saved there is recorded as HTML or something similar and contains link information described as a Uniform Resource Locator (URL). This link information is configured in such a way that a web browser or such may easily achieve access to the information of another page. The other page information is sometimes saved on the same web server, but is sometimes saved on a different web server.

Further, the cellular phone terminal 210 is not only equipped with data communication functions, but also has the widely diffused, standard telephone functions as well; however, in the present embodiment the detailed explanation has been limited to the functions which use the data communication functions and the Bluetooth communications functions to relay the connection from the personal information terminal 200 to the web server 230.

Specifically, in the state when the Bluetooth communications connection between the cellular phone terminal 210 and the personal information terminal 200 has been established, the dial up function provided inside the personal information terminal 200 requests the cellular phone terminal 210 to let it dial the ISP telephone number and thus establishes the link between the cellular phone terminal 210 and the ISP via the cellular phone line network, and additionally, the communications stack provided inside the personal information terminal 200 establishes a virtual communication path between the personal information terminal 200 and the router operated by the ISP, thus functioning as a connection relay.

Note that there are cases in which the network depicted in FIG. 5 is an intranet operated within a company or organization, and there are cases in which it is an internet connected widely around the world.

Returning to FIG. 4, reference numeral 18 indicates an input device, and in the present embodiment this mainly corresponds to the operating button 2 depicted in FIGS. 1A to 1C. An input signal from the input device 18 is inputted to the CPU 12 through an input control circuit 19.

When a power supply is provided to a personal information terminal constructed as explained above, a program stored in the ROM 15 is executed by the CPU 12.

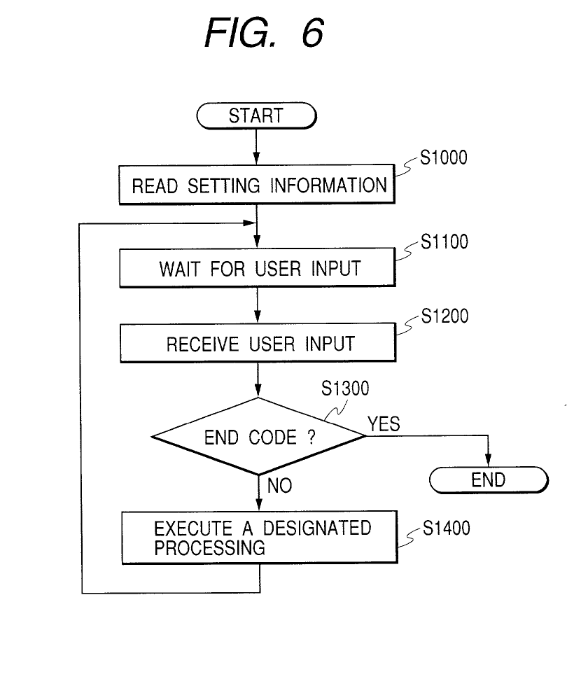

FIG. 6 is a flow chart depicting a sequence of processes of an operations program in the personal information terminal and which is executed by the CPU 12.

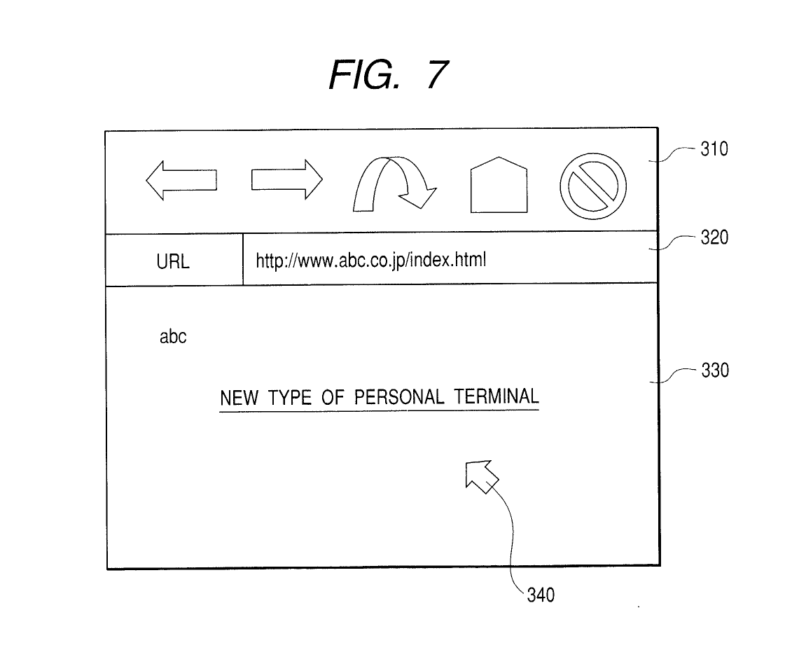

At step S1000 various setting values are read from the ROM 15, the backlight 113 is turned on and an initial screen is displayed on the liquid crystal display device 112 as depicted in FIG. 7.

FIG. 7 is a diagram depicting an initial screen displayed by the liquid crystal display device 112. This initial screen is a browser screen in the present embodiment having functions substantially equivalent to those of the screen of WWW browser software used in a standard fashion with a personal computer.

Reference numeral 310 in the diagram is a button display area in which buttons are arranged for performing browser operations, and reference numeral 320 indicates a URL input area for inputting a URL indicating a file location and filename. Reference numeral 330 is a content display area for displaying content described in HTML. Reference numeral 340 is a cursor indicating an operating position on the screen, and a signal is inputted from the input device 18 to move the cursor 340 on the screen and start and/or select operations. The cursor 340 moves on the screen in accordance with the signal, and when a click is performed on a button in the button display area 310 or on an anchor tag indicating another URL in the content display area 330 then a corresponding command is started.

At step S1100 in FIG. 6 the procedure waits for this user input from the input device 18 using the cursor 340. When the user input is generated, then at step S1200 an input code for this is received.

At step S1300 a determination is made as to whether a code indicating the end of the process has been received from the user or not, and if this code has been received then all of the operations end. If this code has not been received then, at step S1400, processing corresponding to this input code is executed. When this processing ends, the procedure returns to step S1100 and enters the state of waiting for the input.

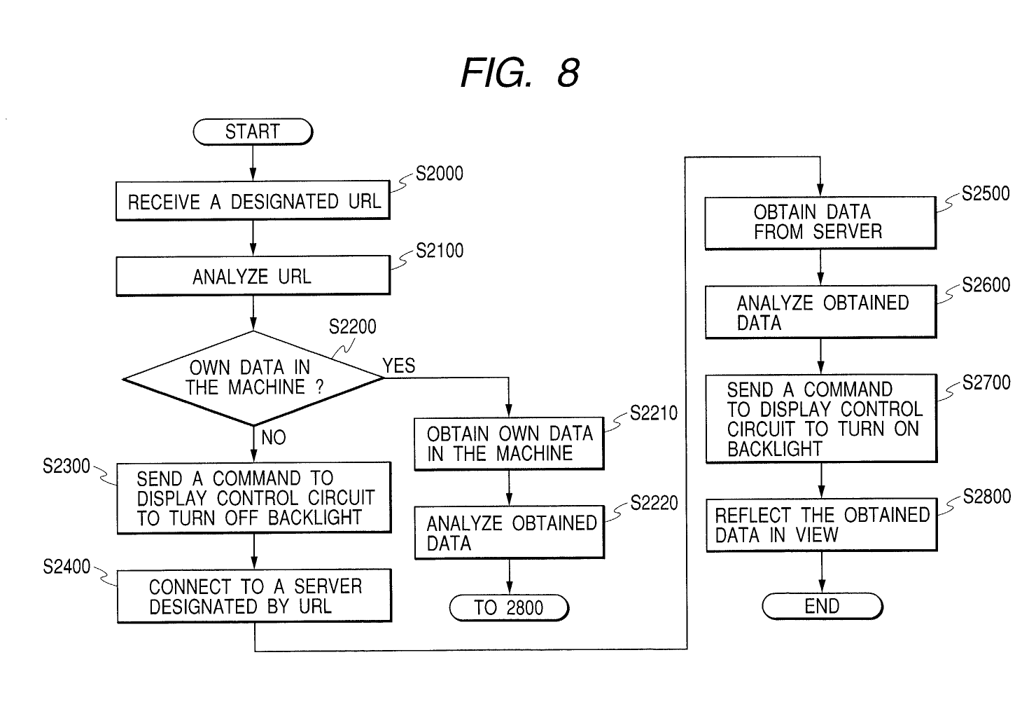

Next, explanation will now be made making reference to FIG. 8 of the type of processing performed at step S1400 which is the most typical processing for the present invention, in which the information indicated by the URL is displayed on the liquid crystal display device 112.

FIG. 8 is a flow chart depicting a sequence of processes for displaying the content indicated by the URL. Note that the URL may be designated either by a method in which the user uses a URL which has been saved in advance, or by a method in which the anchor tags are used for which links are shown in the content display area 330 depicted in FIG. 7, or else by a method in which the user directly inputs the URL (in the present embodiment a soft keyboard is displayed in the screen of the liquid crystal display device 112 and the cursor 340 is moved across the soft keyboard to select characters one by one).

At step S2000 a URL designated by any of the above methods is received, and at step S2100 this URL information is analyzed, and at step S2200, if the results of the analysis of the URL information indicates that the designated URL is a URL which corresponds to data present within the user's own personal information terminal, then the process advances to step S2210, and if this is not the case, then the process advances to step S2300.

At step S2210, the file (i.e., web page data) inside the user's own terminal and which corresponds to the designated URL is obtained from the ROM 15, and then the process advances to step S2220. At step S2220, the content of the file which has thus been obtained is analyzed, converted to display screen information and stored in the RAM 14, and then the procedure advances to step S2800.

On the other hand, at step S2300, a command is sent to the display control circuit 13 to turn off the backlight 113 and the backlight 113 is turned off. At step S2400, the dial-up connection point and the URL information are obtained, and the Bluetooth connection is made to the cellular phone terminal 210 via the communication control circuit 17. Then the dial-up connection is made, the connection to the internet is established and the connection is made to the server designated by the URL.

At the next step S2500, the designated file data is obtained from the server, and then the connection to the server is disconnected and the process advances to step S2600. At step S2600, the obtained information is analyzed, converted to display screen information and then saved to the RAM 14.

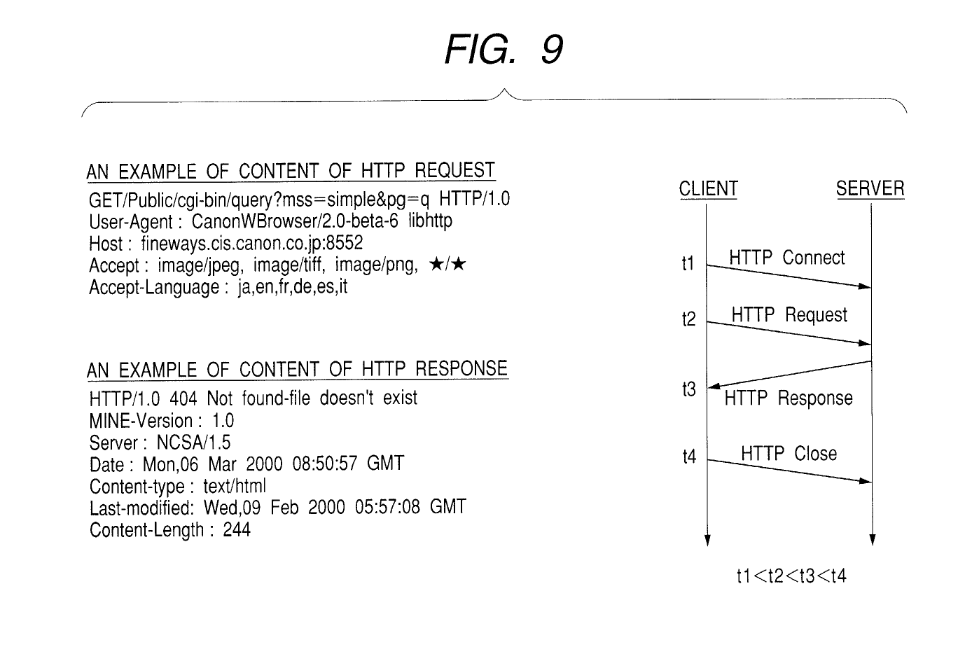

Note that HyperText Transfer Protocol (HTTP) is widely being used for performing transfer of HTML files and such between the cellular phone terminals and servers. FIG. 9 is a sequence chart depicting one typical example of forwarding information by HTTP.

Returning to FIG. 8, at the following step S2700 a command is sent to the display control circuit 13 to turn on the backlight 113 and the backlight 113 turns on. At step S2800, the display screen information being accumulated in the RAM 14 is sent to the display control circuit 13 together with a display command, and is then displayed on the liquid crystal display device 112 and this process ends.

Here, explanation will now be made of operations of a program having a function for configuring the personal information terminal 200.

FIG. 28 is a flow chart for explaining an operation of a program in the personal information terminal 200 which is provided with a function for configuring the personal information terminal 200. This program is called up from step S1400 in FIG. 6 in response to instructions from the user, and this program realizes a function for setting appropriate values indicated by the user for each of a variety of items to be configured in the personal information terminal 200. Specific instructions from the user include such cases as when the setting functions are selected from a menu of items displayed on the display screen, or when the user inputs the settings directly.

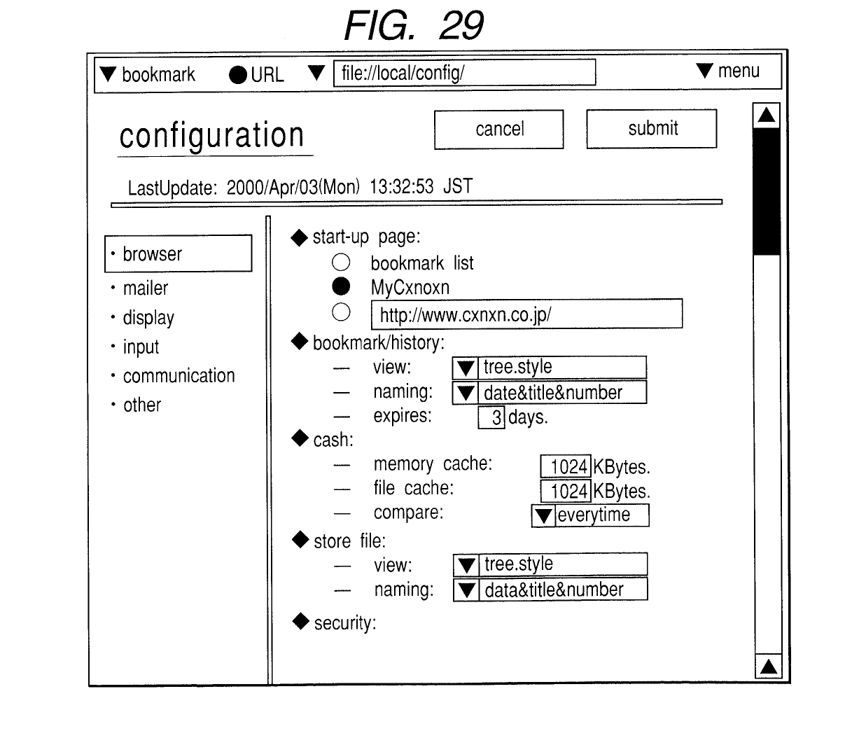

First, at step S3001 the current setting values of the personal information terminal 200 are displayed and the setting session begins. The setting values may be displayed as appears in FIG. 29, for example. Then, at step S3002 the procedure waits for user input. At step S3003 the user input is evaluated. Here, if the user input is a setting end instruction, then the process advances to step S3004. What is meant by the setting end instruction here is either “submit” or “cancel”. On the other hand, if the user input is not a setting end instruction then the procedure advances to step S3007.

At step S3004 another evaluation is made to determine whether the setting end instruction is “submit” or “cancel”. In the case when it is a “submit”, then the procedure advances to step S3005, and after the setting data from the setting session is reflected in the personal information terminal 200 then the process ends. Here, the operation of making the personal information terminal 200 reflect the settings includes saving the settings to the RAM 14. On the other hand, in the case when it is a “cancel” which has been designated, then the process advances to step S3006, and the settings from the setting session are destroyed and then the process ends.

In the case of an input other than a setting end instruction, the user's input which was received in connection with the setting values is shown on the screen together with the data saved during the setting session. Then the procedure returns to step S3002 to wait for the next user input.

In this way, by providing the enlarging optical system 11, being composed of the liquid crystal display device 112, the free-form surface prism 111 and the backlight 113, in an integrated fashion together with the input device 18 and with the CPU 12 and other control processing devices and the radio communications device 16, it thus becomes possible to make an ocular-type large-screen display; and also, by turning the backlight 113 off when it is not needed and turning this sufficiently bright backlight 113 when the screen display is to be performed, it becomes possible to reduce the electricity consumption of the personal information terminal while securing sufficient brightness, with the result that it is possible to provide a compact and portable personal information terminal.

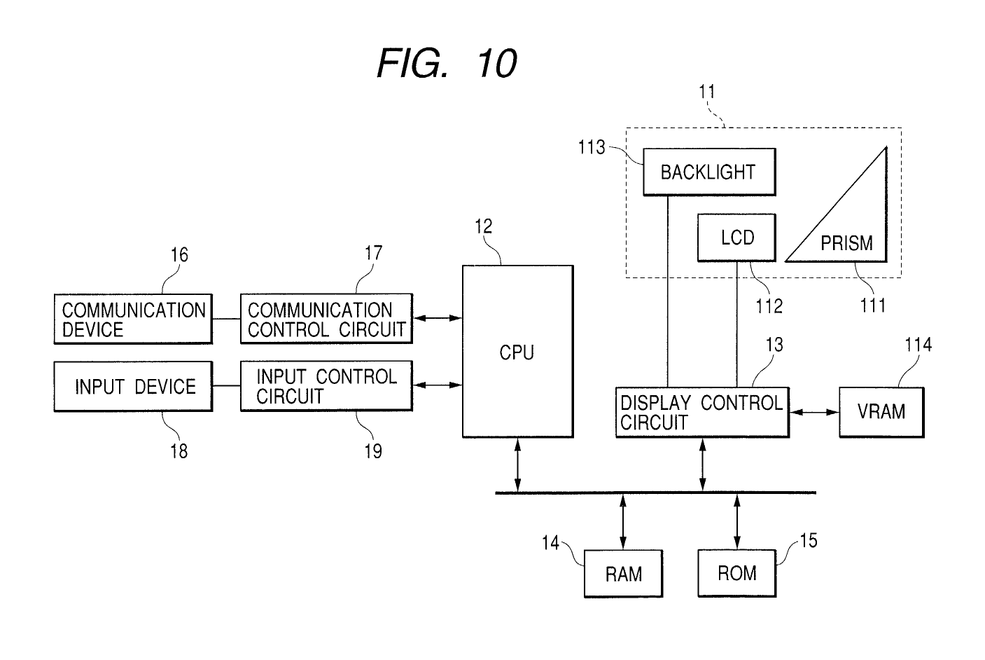

Note that in the first embodiment at step S2220 and step S2600 the analyzed display screen information is accumulated in the RAM 14; however, it is also possible to provide a VRAM 114 to the display control circuit 13 as shown in FIG. 10 and store the display screen information in the VRAM 114. FIG. 10 is a block diagram depicting a construction in which the VRAM 114 has been added to the construction of the personal information terminal depicted in FIG. 4.

Further, in the first embodiment, at step S2300 a command to turn off the backlight 113 is sent to achieve energy efficiency; however, in a construction such as the one mentioned above in which the VRAM 114 has been added, a reduced-energy consumption mode is configured such that the data from the VRAM 114 is not displayed on the liquid crystal display device 112, and at step S2300 the liquid crystal display device 112 is set for this low-energy consumption mode together with the turning off of the backlight 113. As a result, it becomes possible to achieve even greater reduction of consumed energy in addition to turning off the backlight 113. Note that in this case, at step S2700 the command to turn on the backlight 113 is also issued together with a command to the liquid crystal display device 112 for causing it to return to the mode in which it displays the data from the VRAM 114.

Further, in the first embodiment, the transmission-type liquid crystal display was used for the liquid crystal display device 112 as device shown in FIG. 3; however, it is also possible to use a reflection-type liquid crystal display device. In such a case, this is mounted on the free-form surface prism 111 side in such a way that the light emitted from the lamp is reflected off of the surface of the liquid crystal display device 112 and enters the free-form surface prism 111.

Further, in the first embodiment, Bluetooth was used as the communication interface format; however, the communication interface is not limited to this. For example, it is possible to build a data protocol into the information terminal of the present embodiment for conducting communications with the public telephone networks that are used by cellular telephones and PHS telephones, achieving a construction capable of connecting directly to cellular phone networks. In another possible embodiment, it is possible to build a wireless LAN interface into the information terminal and have it make a direct IP connection to access internet data.

(Second Embodiment)

Next, explanation will be made of a second embodiment. Note that the construction of the second embodiment is basically the same as that of the first embodiment, so the explanation of the second embodiment here uses the construction of the first embodiment, and only parts which are different will be explained.

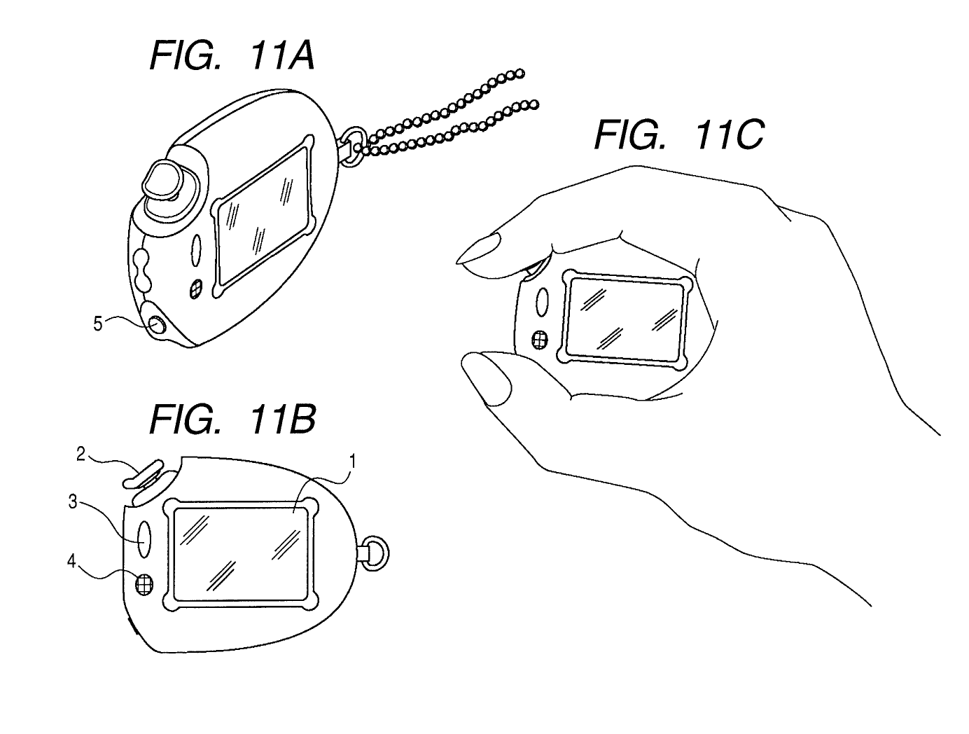

FIGS. 11A to 11C are external views depicting a second embodiment of a personal information terminal equipped with an ocular-type display device according to the present invention. These external views are basically the same as the external view depicted in FIGS. 1A to 1C.

In the second embodiment, a light-emitting diode (LED) 3 and a speaker 4 are added to the left side of the window 1 on the personal information terminal, as viewed from the front. The LED 3 is used to inform the user of the operating status and communications status of the personal information terminal.

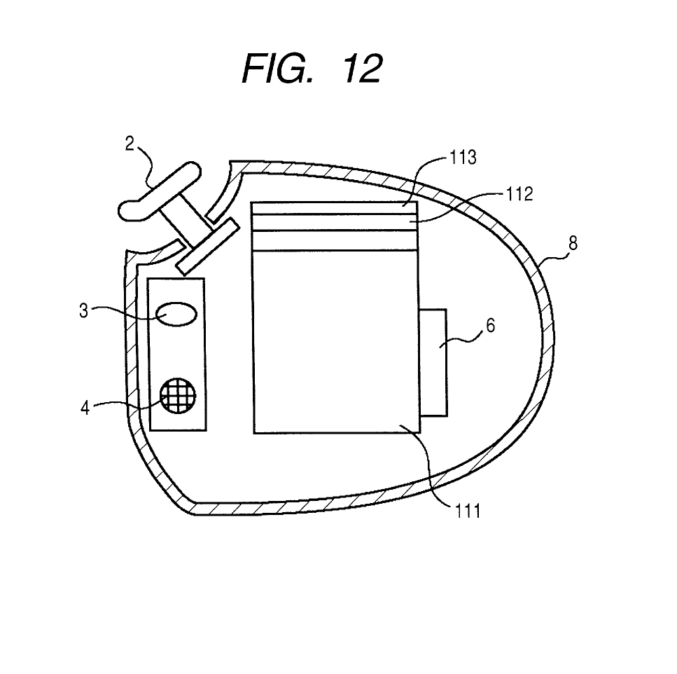

FIG. 12 is a cross-sectional view from the front of the personal information terminal according to the second embodiment.

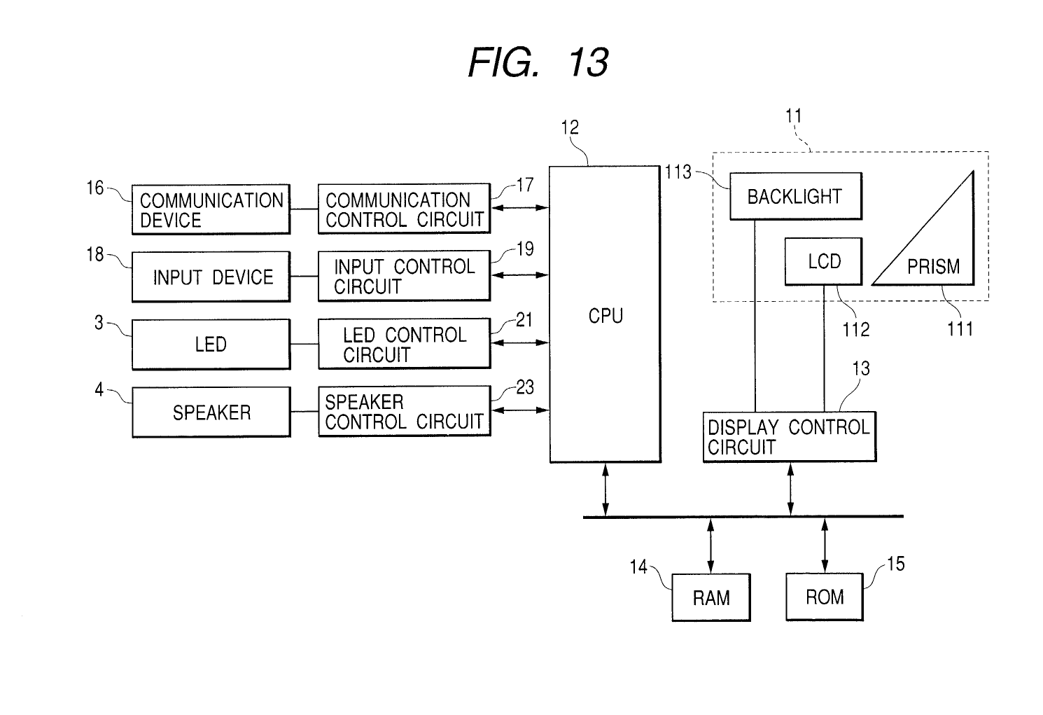

FIG. 13 is a block diagram depicting a construction of the personal information terminal according to the second embodiment. This block diagram is basically the same as the block diagram depicted in FIG. 4.

In the second embodiment, the LED 3 and a LED control circuit 21 for driving and controlling the LED 3 according to instructions from the CPU 12 have been added. Further, the speaker 4 and a speaker control circuit 23 for driving and controlling the speaker 4 according to instructions from the CPU 12 have also been provided.

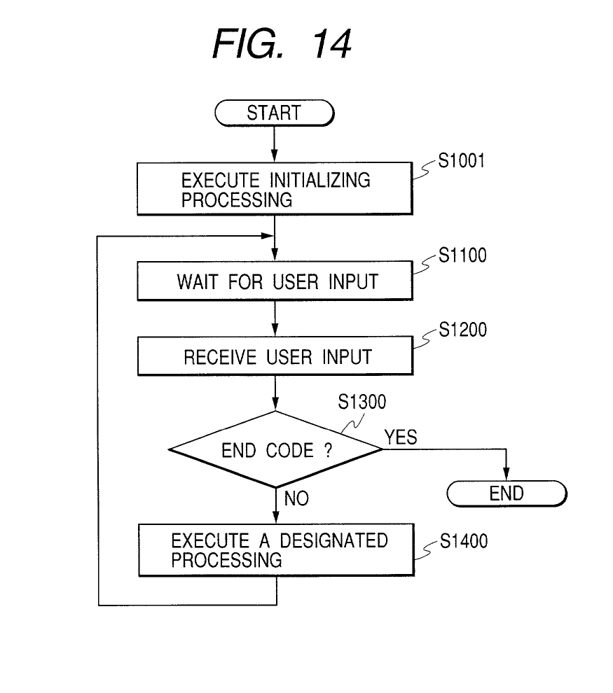

FIG. 14 is a flow chart depicting a sequence of processes of an operations program in the personal information terminal executed by the CPU 112, according to the second embodiment. This flow chart is basically the same as the flow chart of the first embodiment depicted in FIG. 6, so the same reference numerals have been applied to the same steps, and the explanations thereof have been omitted.

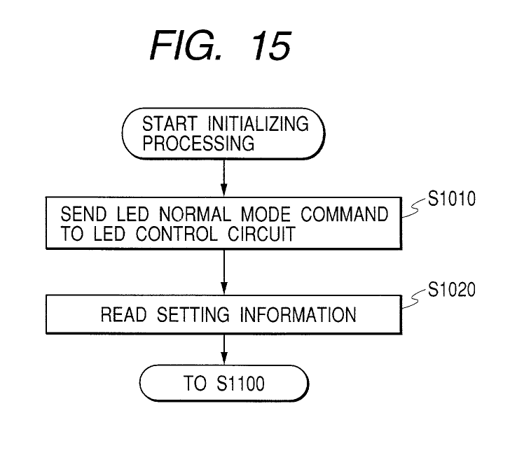

In the second embodiment, at step S1001 an initializing processing is executed. Details of this initializing processing are depicted in FIG. 15.

At step S1010 in FIG. 15, a LED normal mode command is sent to the LED control circuit 21, and the LED 3 is made to light up in green. Then at step S1020, various setting information is read from the ROM 15, and an initial screen such as the one shown in FIG. 7 is displayed as in the case of the first embodiment.

Step S1100 and thereafter are the same as in the first embodiment.

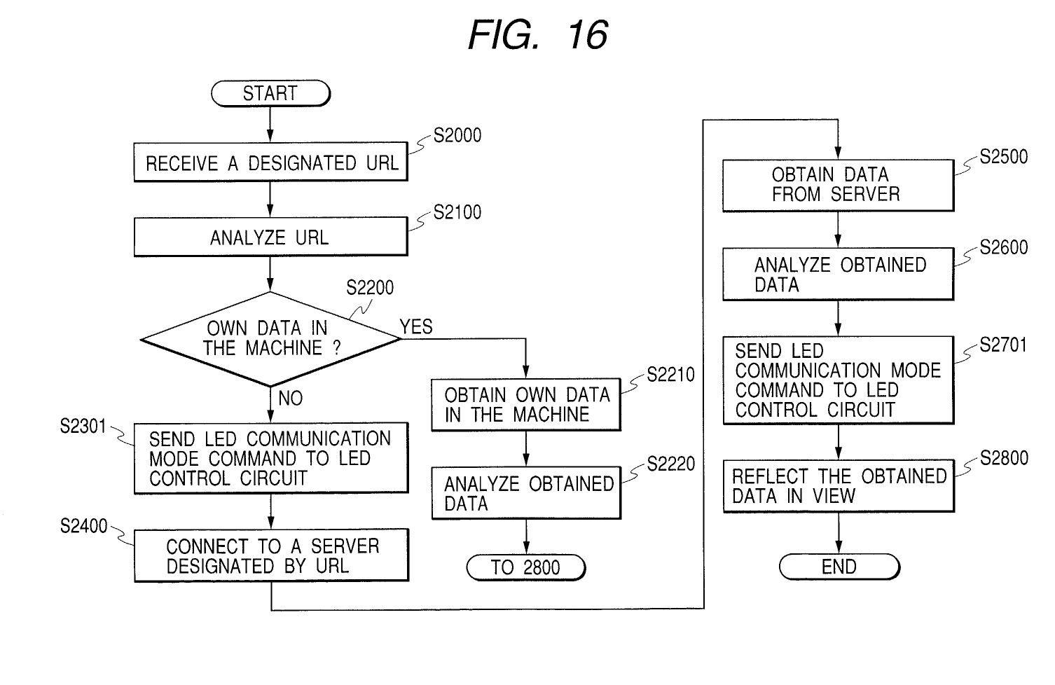

FIG. 16 is a flow chart depicting a sequence of processes for displaying content indicated by the URL according to the second embodiment. This flow chart is basically the same as the flow chart of the first embodiment depicted in FIG. 8, so the same reference numerals have been applied to the same steps, and the explanations thereof have been omitted.

In the second embodiment, at step S2301 a LED communication mode command is sent to the LED control circuit 21, and the LED 3 is made to change from the green indicating its normal mode to a red light. This can be achieved by using a two-color LED; however, in the case when a single-color LED is to be used the green light may be made to flash on and off in order to make the distinction from the normal mode.

Further, in the second embodiment, at step S2701 a LED normal mode command is sent to the LED control circuit 21, and the LED 3 is made to light up in green. Note that in the case of a single-color LED the blinking light is returned to the normal lit state.

The other steps are the same as in the first embodiment.

In the second embodiment as described above, the LED 3 display is different at the normal time and at the time of communication, so the user can turn his eye away from the personal information terminal's window 1 while the communication is being performed. Then the screen display information is obtained from the network side and the communication ends, and then when the user recognizes that the LED 3 display has changed he peers into the window 1 and views the display content. In this way, it is not necessary to peer into the window 1 while in the normal state, and thus the ease of use is improved.

Note that in the second embodiment the LED 3 displays the communication status; however, it is also possible to have the LED 3 display the operation status of the personal information terminal.

Further, in the second embodiment described above the notification that the communication has ended is conveyed to the user by changing the light emitted from the LED 3; however, it is also possible to use the speaker 4 to notify the user that the communication has ended by means of a sound simultaneously with the LED 3 display. The processing in this case may be realized by sending a sound command from the CPU 112 to the speaker control circuit 2 at step S2701 in FIG. 16. Further, it is also possible to notify the user of that the communication has ended by means of the sound from the speaker 4 without using the LED 3.

(Third Embodiment)

Next, explanation will be made of a third embodiment. Note that the construction of the third embodiment is basically the same as that of the second embodiment, so the explanation of the third embodiment here uses the construction of the second embodiment, and only parts which are different will be explained.

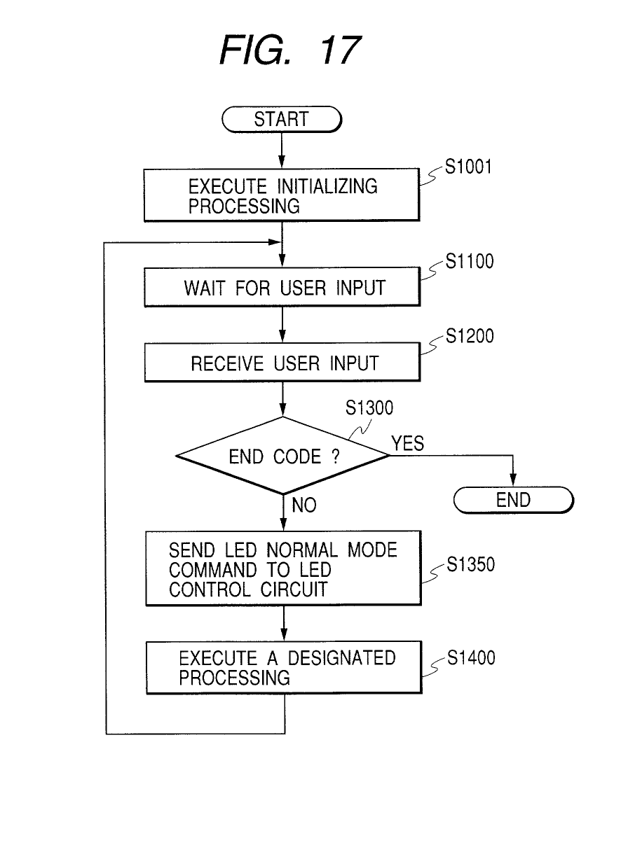

FIG. 17 is a flow chart depicting a sequence of processes of an operations program in the personal information terminal executed by the CPU 112, according to a third embodiment. This flow chart is basically the same as the flow chart of the second embodiment depicted in FIG. 14, so the same reference numerals have been applied to the same steps and the explanations thereof are omitted here.

In the third embodiment a step S1350 is added to the flow chart of the second embodiment depicted in FIG. 14. At step S1350, a LED normal mode command is sent to the LED control circuit 21 and the LED 3 is made to light up in green.

The other steps are the same as those in the case of the second embodiment depicted in FIG. 14.

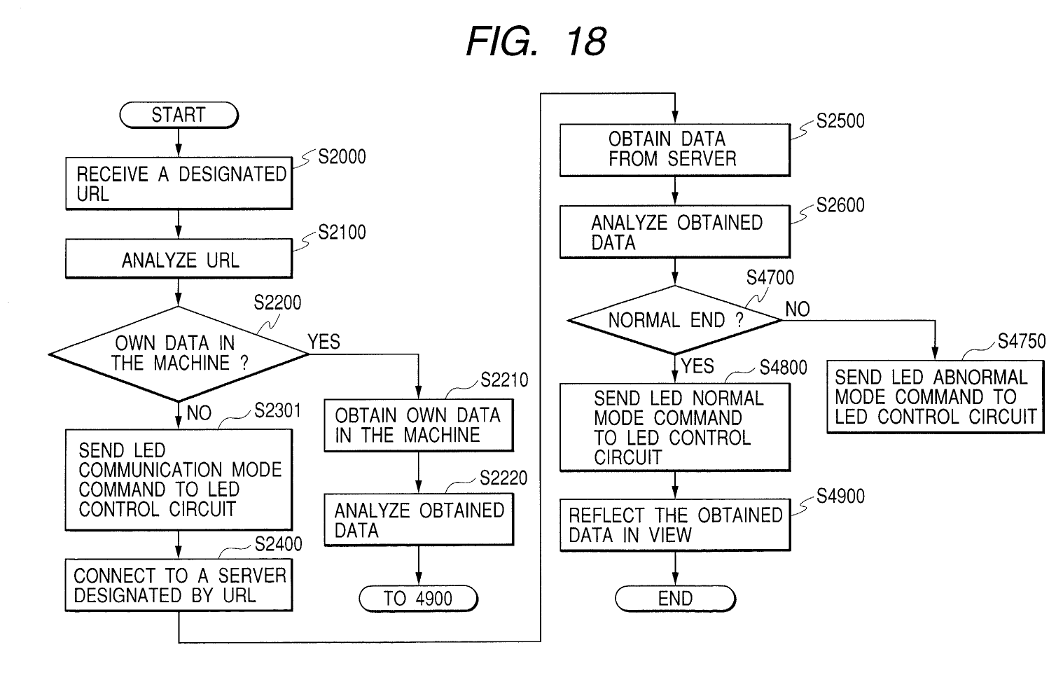

FIG. 18 is a flow chart depicting a sequence of processes for displaying content indicated by the URL, according to a third embodiment. This flow chart is basically the same as the flow chart of the second embodiment depicted in FIG. 16, so the same reference numerals have been applied to the same steps and the explanations thereof are omitted here.

In the third embodiment, the portions following step S2600 are changed to steps S4700 to S4900. Note that at step S2301 the LED normal mode command is sent to the LED control circuit 21, but this makes the LED 3 change from the green color light of the normal mode to an orange color light indicating the communication mode (i.e., the green color and the red color are lit up simultaneously, which was the red in the second embodiment). Note that it is also possible for a blinking green light to express the communication mode instead of the orange color light).

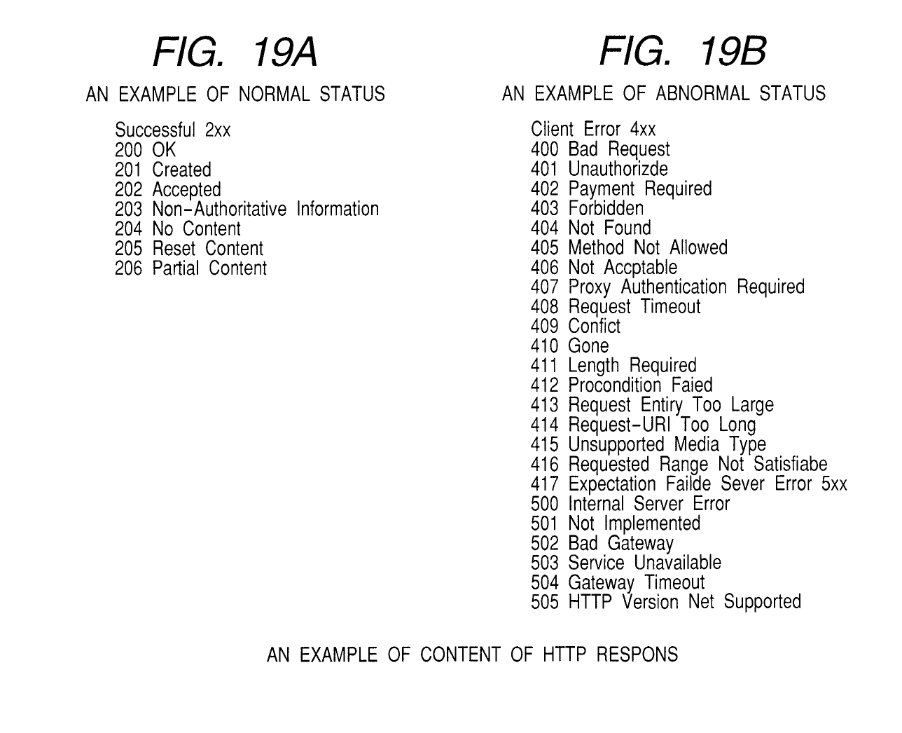

At step S4700, a determination is made as to whether the communication to obtain the data has ended normally or not, and if it has ended normally then the procedure advances to step S4800, and if not, then it advances to step S4750. In the case of HTTP protocol, this determination at step S4700 is performed by analyzing response commands as shown in FIGS. 19A and 19B. For example, in an example of normal status shown in FIGS. 19A and 19B, if a command between command 20 and command 206 is received, then the status is determined to have ended normally. Alternatively, in an example of abnormal status as shown in FIG. 19B, if a command between command 400 and command 505 is not received, then it is determined to have ended normally.

At step S4750, a LED abnormal mode command is sent to the LED control circuit 21 and the LED 3 is changed to a red light. Then the process advances to step S4900.

At step S4800, the LED normal mode command is sent to the LED control circuit 21 and the LED 3 is changed to a green light. Then the process advances to step S4900.

At step S4900, the display screen information which has been accumulated in the RAM 14 is sent to the display control circuit 13 together with a display command, and the liquid crystal display device 112 is made to perform the display and the process ends.

In this way, in the third embodiment, when in the normal mode the LED 3 lights up in green, and in the communication mode, which is its communication state, the LED 3 lights up in orange or blinks in green. Further, in the case when the communication was not normally performed the LED 3 lights up in red, and in the case when the communication was performed normally and has ended the LED 3 lights up in green. Accordingly, even if the user does not peer into the window 1 of the personal information terminal he can tell from the display of the LED 3 when the terminal is communicating, when it has completed communication in a normal way and when it has completed communication in an abnormal way, which improves the utility of the personal information terminal. Further, the user can tell when the communication ends whether it has ended normally or whether it has ended abnormally before he peers into the window 1, so he can proceed to a subsequent procedure smoothly.

Further, in the second embodiment and the third embodiment, the free-form surface prism 111 substantially forms a triangle-shaped column as shown in FIG. 2 and FIG. 12, and the LED 3 and the speaker 4 are arranged on a bottom-surface side of this triangle-shaped pillar as shown in FIG. 12. In other words, it is easy to create an open space at the housing 8 on the bottom-surface side of the triangle-shaped pillar of the free-form surface prism 111, so it is possible to use this empty space for storing the LED 3 and/or the speaker 4 and make the personal information terminal more compact.

Note that in the third embodiment described above it is also possible for each type of status to be displayed in accordance with the way the LED 3 is lit up and then at the same time use the speaker 4 to make noises to notify the user as to whether communications have ended normally or have ended abnormally. Processing in such a case can be achieved by sending an abnormal end mode command from the CPU 112 to the speaker control circuit 23 at step S4750 in FIG. 18, or by sending a normal end command from the CPU 12 to the speaker control circuit 23 at step S4800. The sound outputted from the speaker may be, for example, a continuous sound outputted across a given duration of time for in the case of the normal end mode, and an intermittent sound outputted across a given duration of time in for in the case of the abnormal end mode. Additionally, it is also possible not to use the LED 3 and use only the sound output from the speaker 4 described above.

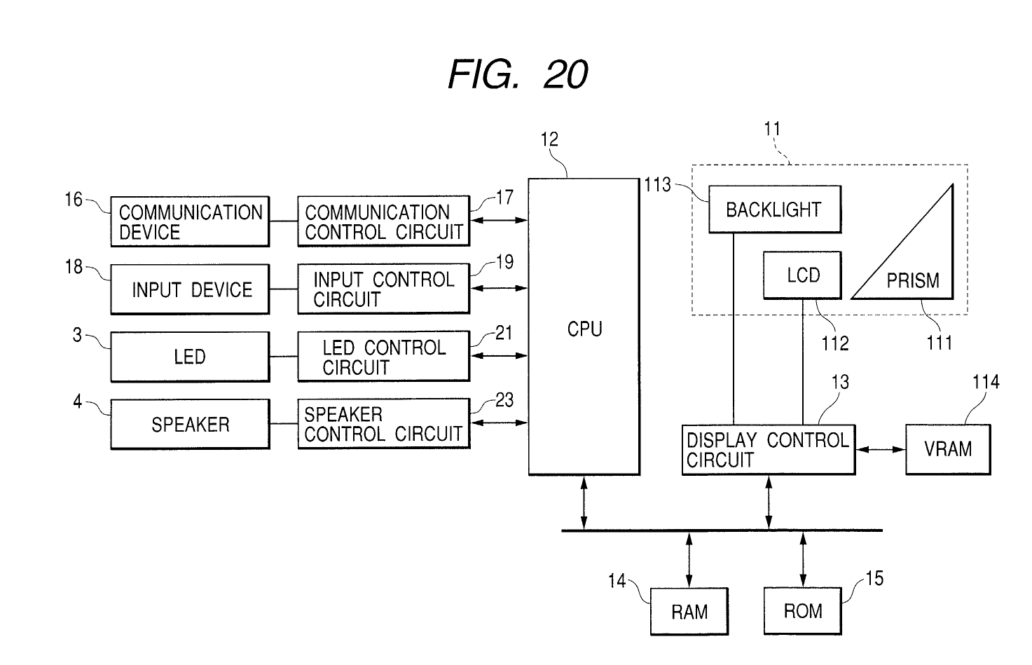

Further, in step S2220 and step S2600 of the second embodiment and the third embodiment the analyzed display screen information is accumulated in the RAM 14; however, it is also possible to provide the VRAM 114 to the display control circuit 13 and accumulate the display screen information in the VRAM 114 as shown in FIG. 20. FIG. 20 is a block diagram of a construction in which the VRAM 114 has been added to the construction of the personal information terminal depicted in FIG. 13.

Further, in the second embodiment and Third Embodiment the transmission-type liquid crystal display device was used for the liquid crystal display device 112 as in the first embodiment; however, it is also possible to use a reflection-type liquid crystal display device. In such a case the backlight 113 is not provided, and a light is mounted on the free-form surface prism 111 side in such a way that the light emitted from the lamp is reflected off of the surface of the liquid crystal display device 112 and enters the free-form surface prism 111.

Further, in the second embodiment and third embodiment Bluetooth was used as the communication interface format as in the first embodiment; however, the communication interface is not limited to this. For example, it is possible to build a data protocol into the information terminal of the present embodiment for conducting communications with the public telephone networks that are used by cellular telephones and PHS telephones, achieving a construction capable of connecting directly to cellular phone networks. In another possible embodiment it is possible to build a wireless LAN interface into the information terminal and have it make a direct IP connection to access internet data.

Further, in the second embodiment and the third embodiment HTTP was used as the communication protocol; however, the present invention is not limited to this. Particularly in the third embodiment it is possible to use communication protocols other than HTTP if there is information included which makes it possible to determine whether or not the response from the server has ended normally or not.

(Fourth Embodiment)

Next, explanation will be made of a fourth embodiment.

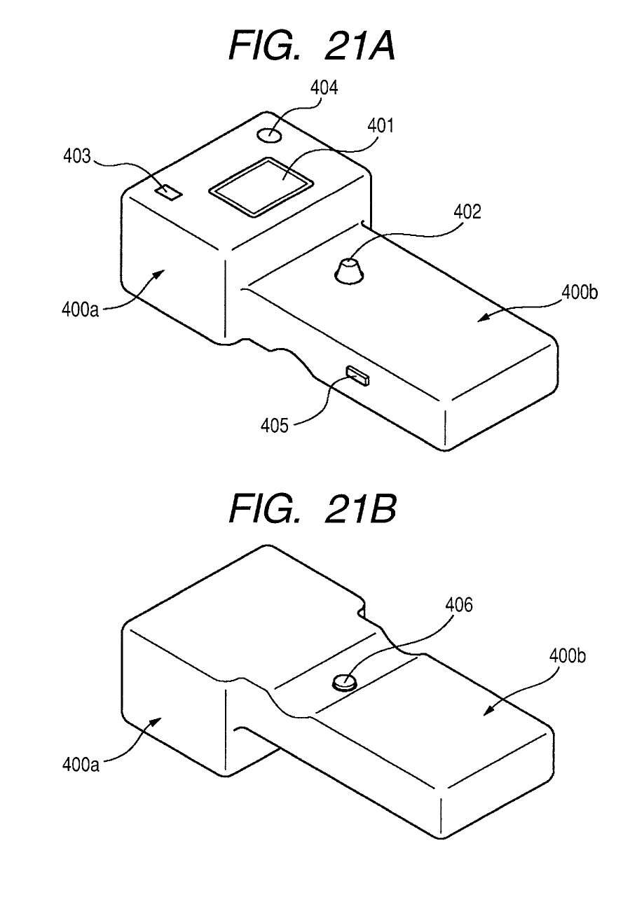

FIGS. 21A and 21B are external views depicting the fourth embodiment of a personal information terminal equipped with an ocular-type display device according to the present invention. FIG. 21A is an external view of the personal information terminal viewed from a substantially frontal angle, and FIG. 21B is an external view from a substantially rear angle.

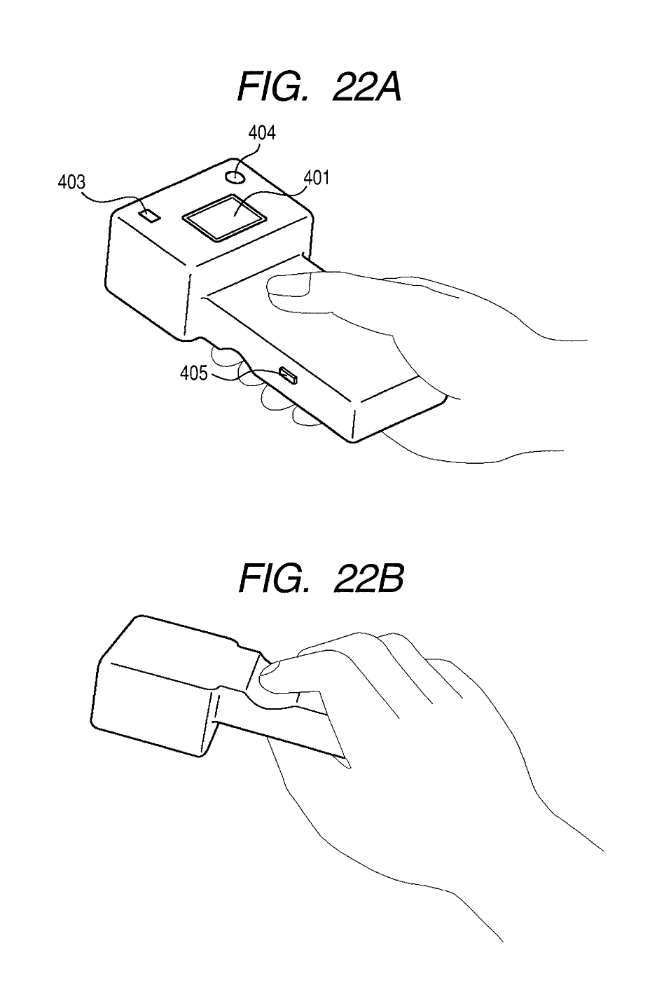

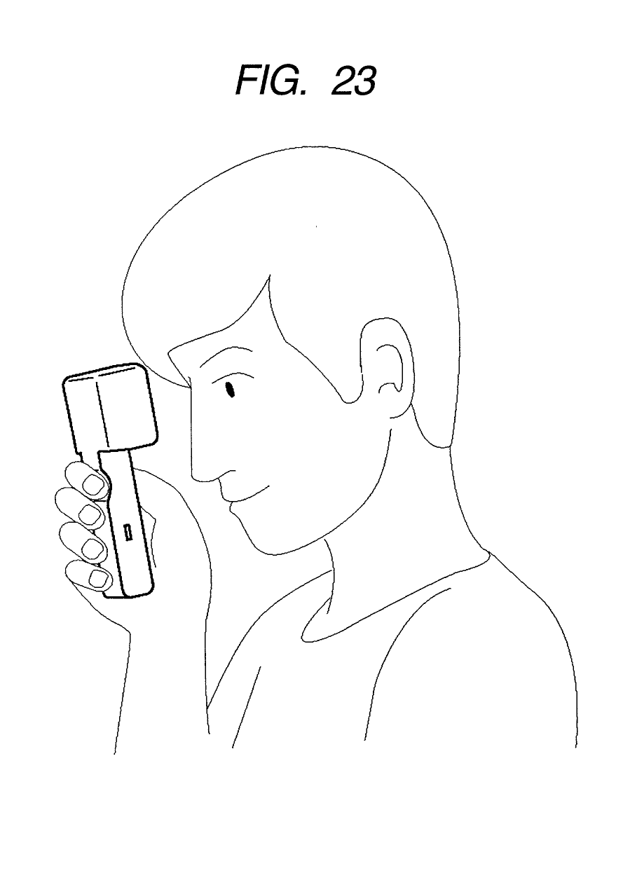

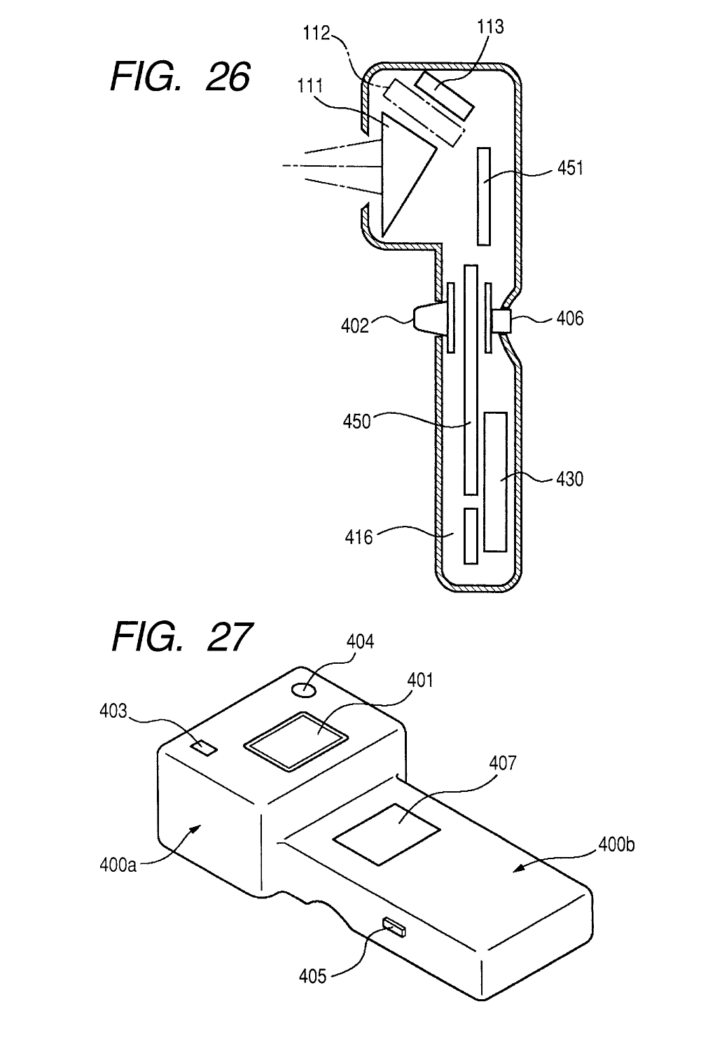

The personal information terminal is composed of a display portion 400a and a grip portion 400b, and the display portion 400a has a display window 401. The display window 401 has a construction similar to the window 1 in the first embodiment depicted in FIG. 2 and FIG. 3, and on the inside there is provided the freeform surface prism 111, the liquid crystal display device (LCD) 112 and the backlight 113 as will be described below with reference to FIG. 26. The user grips the grip portion 400b in hand as shown in FIGS. 22A and 22B and FIG. 23, brings his eye close to the display window 401 and peers inside, whereby the screen from the liquid crystal display device 112 can be seen in an enlarged fashion.

FIGS. 22A and 22B are views depicting the personal information terminal of the present embodiment as it is gripped in the user's hand, and FIG. 22A is an external view of the personal information terminal viewed from a substantially frontal angle and FIG. 22B is an external view from a substantially rear angle. FIG. 23 is a view depicting the user having brought the personal information terminal to his eye, peering into it and operating it.

As shown in FIGS. 21A and 21B, the grip portion 400b has a pointer 402 provided on its front side and a selection button 406 provided on its back side. The pointer 402 is manipulated by the user's thumb as shown in FIG. 22A, and the selection button 406 is manipulated by the user's index finger as shown in FIG. 22B, whereby the user can make needed information be displayed on the display window 401. A stick pointer commonly used for personal computers, for example, may be used for the pointer 402.

Note that on the back side of the housing portion where the selection button 406 is located there is a curved groove suitable for guiding the index finger as shown in FIG. 21B, whereby the grip portion 400b becomes easy to hold and a shape is achieved which is good for pressing the selection button 406. Further, as shown in FIG. 23, when the user peers into the display window 401 the user's thumb comes to a position proximate to his cheek, so making the grip portion be recessed deeper than the display unit 400a by a distance of equal to or greater size than the thickness of the thumb allows the thumb not to touch the user's cheek while the user is performing operations.

Returning to FIGS. 21A and 21B, an on/off power switch 405 is provided to a left side of the grip portion 400b as viewed from the front side, and an LED 403 and speaker 404 are provided to a front side of the display unit 400a. The LED 403 and the speaker 404 are used to indicate the operating status of the personal information terminal in a similar way as the LED 3 and the speaker 4 of the second embodiment depicted in FIGS. 11A to 11C.

On the display portion 400a a frame surrounding the display window 401 is painted black, whereby reflected exterior light is prevented from entering into the surface of the free-form surface prism 111 and making the screen difficult to see.

Note that the electrical power source for the personal information terminal can be a battery, and it is possible to equip the terminal with radio communication functions; therefore, it is not necessary to provide an electrical power supply cable or a communications cable.

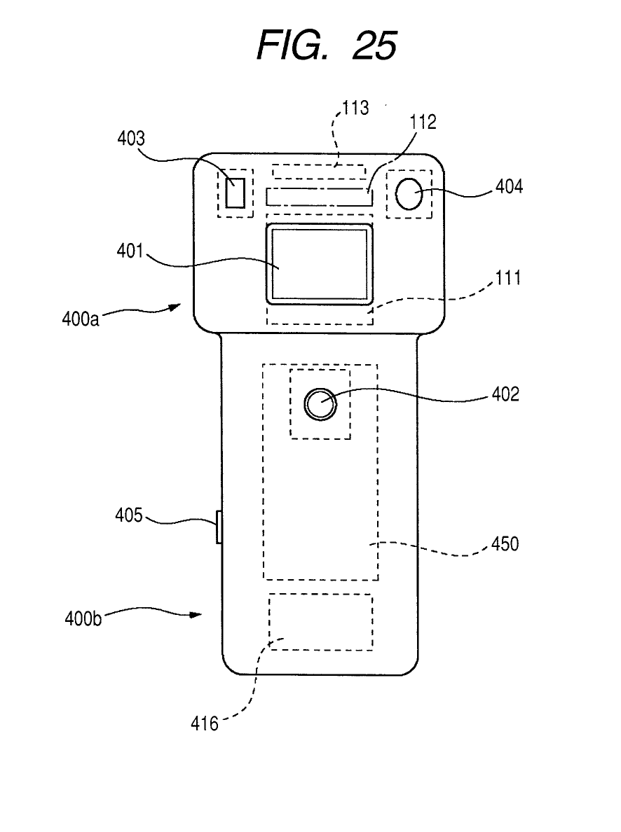

The construction of the optical system for displaying the screen is the same as the construction described above in connection with the first embodiment, so the same reference numerals have been used as in the first embodiment (cf. FIG. 25 and FIG. 26), and the explanations thereof have been omitted.

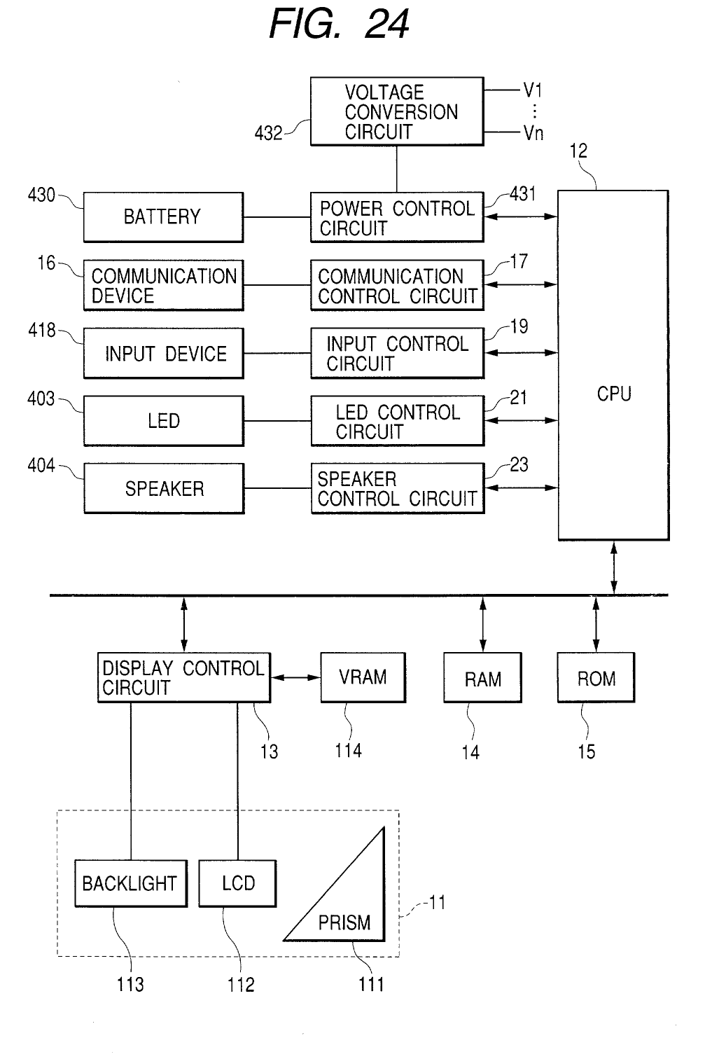

FIG. 24 is a block diagram depicting a way of electronically constructing the personal information terminal according to the fourth embodiment. The electronic construction of the personal information terminal according to the fourth embodiment is basically the same as the electronic construction of the personal information terminal as shown in FIG. 20, so the same reference numeral have been applied to the same portions and explanations thereof are omitted.

In the fourth embodiment, an input device 418 corresponds to the pointer 402, the selection button 406 and the on/off power switch 405 described above. An input signal from the input device 418 is inputted to the CPU 12 via an input control circuit 19.

The LED 403 mentioned above is controlled by the CPU 12 by the LED control circuit 21, and the speaker 404 is controlled by the CPU 12 via the speaker control circuit 23. Both of these are used to inform the user of the operation status of the personal information terminal.

Reference numeral 430 is a battery for supplying the power source to the personal information terminal. Lithium ion batteries, for example, may be used because they are suitable with respect to size, longevity and other characteristics. Reference numeral 431 is a battery control circuit, which controls the battery 430 based on instructions from the CPU 112. Reference numeral 432 is a voltage converter circuit, which is for converting the voltage provided from the battery 430 into voltages for driving each of the circuits and then supplying these voltages to the circuits.

FIG. 25 and FIG. 26 are transparent views depicting an internal construction of the personal information terminal. FIG. 25 depicts this from the front, and FIG. 26 from the side.

That is, the display portion 400a is stored in the housing such that the free-form surface prism 111 is made to face opposite to the display window 401 of the ocular contact piece, and the liquid crystal display device (LCD) 112 is arranged on a diagonal upper portion and the backlight 113 is arranged on a diagonal upper portion even further up.

Reference numeral 451 depicted in FIG. 26 is a display control substrate on which the display control circuit 13 and the VRAM 114 of FIG. 24 are mounted. Reference numeral 450 is a main substrate which has the CPU 12, the RAM 14, the ROM 15 and such mounted thereto. Reference numeral 416 is a communications device comprised of an antenna and such for the Bluetooth communications. The battery 430 is arranged on a rear portion of the main substrate 450 as viewed from the front of the personal information terminal. The other elements comprising the personal information terminal are not depicted here, but they are all connected to a bus or a cable or such, and they comprise a circuit such as is shown in FIG. 24.

In the above construction, when the user uses the on/off power switch 405 to supply the power source the program being stored in the ROM 15 is executed and a screen is displayed on the liquid crystal display device 112 which is similar to the one shown in FIG. 7 for the first embodiment.

Note that in the fourth embodiment, the signal that is inputted from the pointer 402 is treated as the signal for moving the cursor 340 (see FIG. 7) on the screen. In the case when the pointer 402 is a stick pointer, it is possible to move the pointer 402 in any desired direction on the two-dimensional plane where the pointer 402 has been placed, and the direction in which the pointer 402 is moved and the force with which it is moved are outputted on the plane as a vector amount. By making this vector amount be reflected in the movement of the cursor 340 on the screen, the cursor 340 moves in the direction in which the user moved the pointer 402 and the speed at which the cursor 340 moves is determined in accordance with the force with which the pointer 402 is moved. The surface on which the pointer 402 has been placed and the and the display surface are parallel to each other, so the movement of the pointer 402 and the movement of the cursor 340 on the screen match each other; therefore, the user will not be confused when manipulating the pointer 402.

Hereinafter, explanation will be made making reference to FIG. 7. When the user manipulates the pointer 402 to move the cursor 340 on the screen, and moves the cursor 340 to a desired icon in the area 310 and depresses the selection button 406, then an operation corresponding to that icon may start. For example, if the cursor 340 is moved to an icon in the area 310 having a left arrow and the selection button 406 is depressed, then the page which was being displayed immediately previously is displayed in the area 330.

Here it is possible to have a function for sensing that the selection button 406 has been depressed and sending an “on” signal to an input control circuit 19. In other words, common methods for designating the URL for the web browser include a first method in which the user designates information which has been registered in advance as a bookmark, a second method in which the designation is made by clicking an anchor tag on which a link destination is displayed in the contents display area 330 shown in FIG. 7, and a third method in which the user inputs the URL information directly. As is explained in connection with the methods of designating the URL in the first method and the second method, this designation can be achieved with just the manipulation of the pointer 402 and the selection button 406 described above. Further, in the case of the third method, if a format is adopted such that a soft keyboard is displayed on the screen shown in FIG. 7 and the cursor 340 is moved across the soft keyboard and the inputted characters are determined with the selection button 406, then this third method can also be achieved by manipulating only the pointer 402 and the selection button 406.

Hereinafter, the sending and receiving of information and the notifications of the operating state of the personal information terminal are achieved by means of the same processing as in the Embodiments 1 to 3. Also, the LED 403 and the speaker 404 shown in FIGS. 21A and 21B are arranged on the front surface of the display portion 400a; however, it is also possible to arrange these on a side surface of the display portion 400a.

Further, in the fourth embodiment, the pointer 402 is arranged on the front surface of the grip portion 400b and is operated by the thumb while the selection button 406 is arranged on the back side of the grip portion 400b and is operated by the index finger; however, instead of this arrangement it is also possible to arrange a selection button on the front side of the grip portion 400b to be operated with the thumb and arrange a pointer on the back side of the grip portion 400b to be operated with the index finger. This is consistent with the essence of the present invention and exactly the same effect may be obtained as in the case of the fourth embodiment described above.

Further, in the fourth embodiment, the pointer 402 for moving the position of the cursor 340 on the display screen and the selection button 406 for starting a process of the icon or such located at the position of the cursor 340 were used; however, instead of such a construction it is also possible to use a pointer which has both of these functions. That is to say that in addition to having the same functions as the pointer 402 for moving the position of the cursor 340, the pointer can also be made to have the push button function such that when the user moves the pointer user up and down, left and right across the flat plan on which the pointer has been placed, the cursor 340 is moved up and down, left and right on the screen, and when the user pushes the pointer in a direction perpendicular to the flat plane on which the pointer has been placed, the process of the icon or such located at the position of the cursor 340 is made to start. By using the pointer constructed in this way, the selection button 406 becomes unnecessary and the user becomes able to achieve the functions mentioned here by manipulations performed just with the thumb. Note that it is also possible to arrange this pointer at the position of the selection button 406 depicted in FIG. 21B. In such a case there is nothing placed at the position of the pointer 402 depicted in FIG. 21A. A construction such as this enables the user to achieve the functions mentioned here by manipulations performed just with the index finger.

(Fifth Embodiment)

Next, explanation will be made of a fifth embodiment.

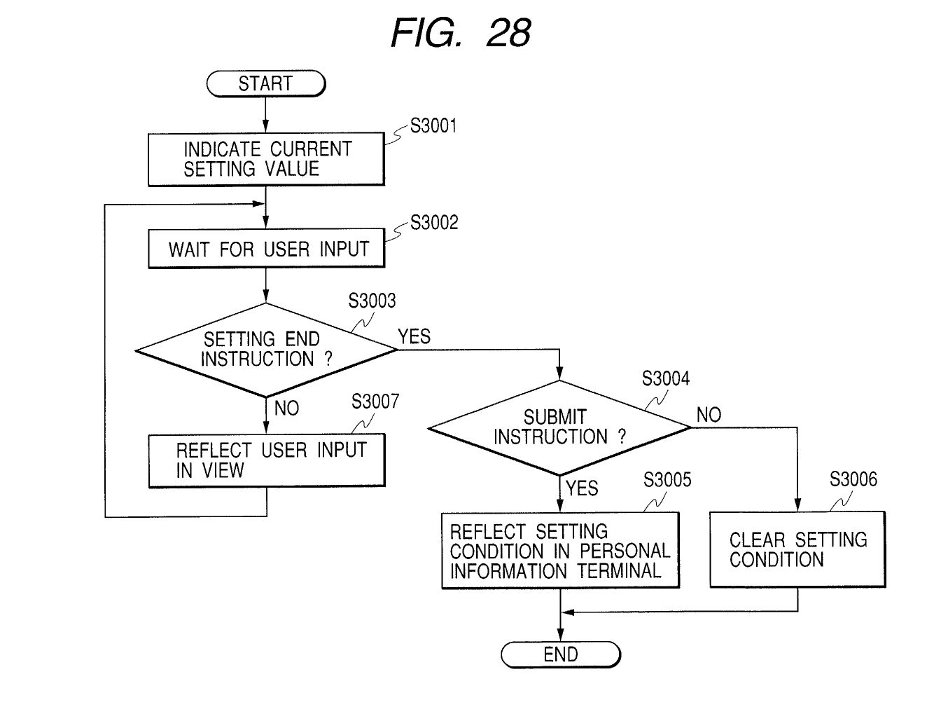

FIG. 27 is an external view of a fifth embodiment of a personal information terminal equipped with an ocular-type display device according to the present invention. The construction of this Fifth Embodiment is basically similar to the construction of the fourth embodiment, so the same reference numerals have been applied to the same portions, and their explanations are omitted here.

In the fifth embodiment a touch pad 407 is used instead of the pointer 402 in the fourth embodiment which was a stick pointer. This touch pad 407 is the static electricity capacity format pointing device frequently used in note-type personal computers. Like the stick pointer, the touch pad 407 outputs a vector value on an XY plane in accordance with movements of the finger. In other words, in the case of the stick pointer, the absolute value of the vector is proportionate to the force with which the pointer is pushed; however, in the case of the static electricity capacity format touch pad 407, the absolute value of the vector is proportionate to the amount of distance that the finger was made to slide.

When the user slides his thumb on the touch pad 407 to make the cursor 340 move and the cursor 340 reaches the desired position, the user then pushes the selection button 406 with his index finger. The selection button 406 is arranged on the back side of the grip portion 400b in the same way as in the fourth embodiment.

The other operations are exactly the same as in the fourth embodiment.

Note that in the fifth embodiment described above, the touch pad 407 is arranged on the front surface of the grip portion 400b to be manipulated with the thumb, and the selection button 406 is arranged on the back side of the grip portion 400b to be manipulated with the index finger; however, instead of this arrangement it is also possible to arrange a selection button on the front side of the grip portion 400b to be operated with the thumb and arrange a touch pad on the back side of the grip portion 400b to be operated with the index finger. This is consistent with the essence of the present invention and exactly the same effect may be obtained as in the Embodiment described above.

Further, in the fifth embodiment described above, the touch pad 407 and the selection button 406 were used; however, it can also be achieved by making the static electricity capacity format touch pad have both of these two functions. That is to say that by making the static electricity capacity format touch pad have the push button function as well, when and the user moves his thumb up and down, left and right on the touch pad then the cursor 340 is moved up and down, left and right respectively, and when the user strikes the touch pad in a perpendicular direction (i.e., when the user taps the touch pad) the corresponding to an icon or such at the position where the cursor 340 is located is made to start. By using the touch pad constructed in this way, the selection button becomes unnecessary and the user becomes able to achieve the functions mentioned here by manipulations performed just with the thumb. Note that it is also possible to arrange this touch pad on the back side of the grip portion 400b at the position of the selection button. In such a case there is nothing placed on the front side of the grip portion 400b at the position of the touch pad 407. A construction such as this enables the user to achieve the functions mentioned here by manipulations performed just with the index finger.

Additionally, even in the case of a construction in which a tappable touch pad is provided to the front surface of the grip portion 400b, a selection button is provided to the rear surface of the grip portion 400b and the user taps the touch pad, it is still possible to have the process for the icon or such where the cursor 340 is located be started. Or, on the other hand, it is also possible to provide the selection button to the front side of the grip portion 400b and provide a tappable touch pad to the back surface of the grip portion 400b, to be operated similarly. This produces a result that the user's degree of freedom in operation is increased.

(Sixth Embodiment)

Regarding a sixth embodiment of the present invention, explanation will be made of an example using the personal information terminal of the present invention as a digital camera, video camcorder, or other such remote control instrument (hereinafter, “remote controls”). In particular, use of the personal terminal of the present invention is particularly effective for realizing “viewable remote control”, in which visual images such images taken with a digital camera, video camcorder and the like are taken, checking and confirming these images as image data while taking them. In order to make the explanation of the sixth embodiment of the present invention concise, explanation will be made of an example applied to a digital camera remote control.

A construction of the personal information terminal according to the sixth embodiment of the present invention uses a similar hardware construction as the one used in the first embodiment described above. However, as a software construction for this, a program for receiving and displaying image data sent from the digital camera to the personal information terminal of the present invention, and a program for manipulating the digital camera from the personal information terminal of the present invention are added.

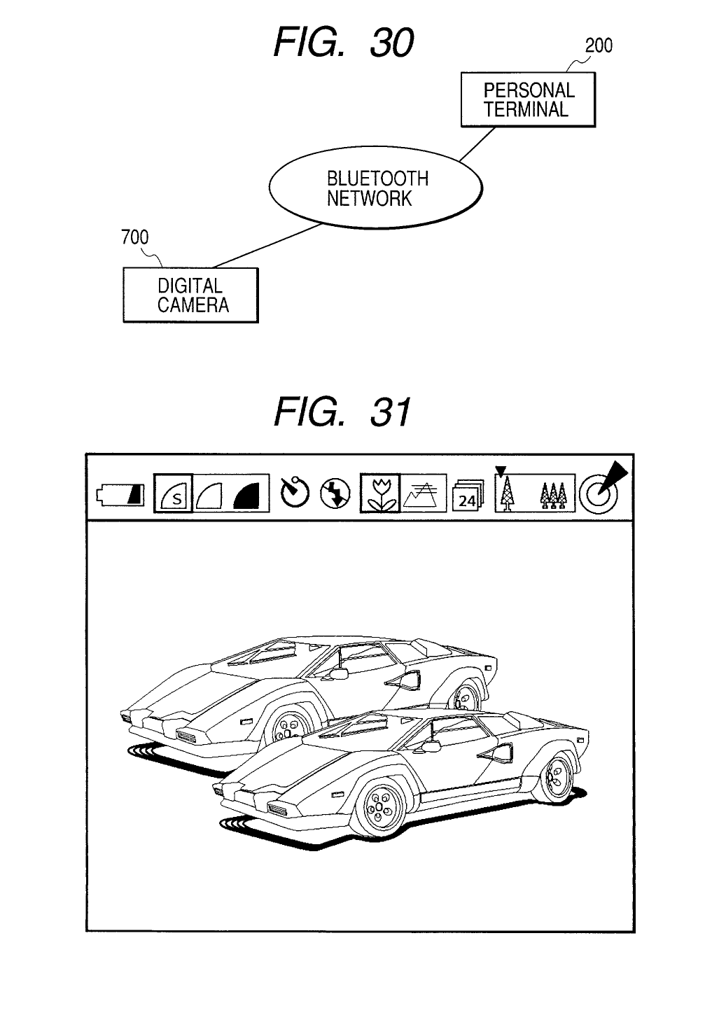

FIG. 30 is an explanatory diagram depicting a connection between a personal information terminal 100 according to the sixth embodiment of the present invention, and a digital camera 700. In the fifth embodiment of the present invention, the personal information terminal 200 and the digital camera 700 are connected by means of the Bluetooth communications technology. Then an image signal obtained from image capturing elements of the digital camera 700 and status information about the status of the digital camera are sent through the Bluetooth communications technology to the personal information terminal personal information terminal 200 which is being used as the remote control. And in a similar fashion, a manipulation signal is sent over to the digital camera 700 from the personal information terminal 200 being used as the remote control.

FIG. 31 is an explanatory diagram depicting a typical display example according to the sixth embodiment of the present invention. In the sixth embodiment of the present invention, a Graphical User Interface (GUI) to operate as a manipulations interface for manipulating the digital camera 700 is displayed on an upper portion of the screen of the personal information terminal 200, and on a lower portion of the screen there is displayed the image signal sent from the digital camera 700.

The GUI serving as the manipulations interface in the upper portion of the screen is also displaying the status information sent from the digital camera, and going from left to right there is displayed a remaining battery capacity, a number of pixels used for memory (ex, superfine, fine or normal), a self-timer, a strobe off setting, a mode setting or distant view mode), a possible number of pictures that can be taken, a zoom (ex, zoom in and zoom out) and a shutter button.

The current status of the digital camera 700 depicted in FIG. 31 indicates that the remaining battery capacity is minute, the number of pixels being used for memory is set at superfine, the self-timer is not being operated, the strobe is turned off, macro mode is turned on, 24 more pictures can be taken, the zoom is set for a longer distance view and the status is such that a picture can be taken (i.e., the shutter button may be pushed). The user manipulates the digital camera 700 which is connected through this interface screen.

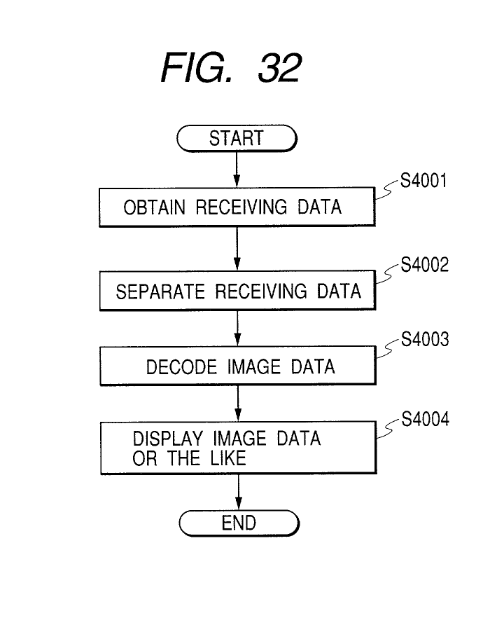

FIG. 32 is a flow chart for explaining an operation of a program for receiving image data and the like sent to the personal information terminal 200 from the digital camera 700, according to the sixth embodiment of the present invention. This program is a program for calling up step S1400 depicted in FIG. 6 in response to the arrival of communication data from the communications device 16, and the program realizes a function for receiving and displaying the image data obtained from the image capturing elements of the digital camera 700 and the status information about the status of the digital camera.

First, at step S4001 the data which has arrived at the communications device is obtained. Next, at step S4002 the obtained data is separated into image data and digital camera status information. Next, at step S4003 the image data is decoded. For example, in the case when compressed data has been sent from the digital camera 700 in a Joint Photographic Expert Group (JPEG) format, for still color image compression, the image data is obtained according to a decoding format based on JPEG rules. Then, at step S4004, the obtained image data and the digital camera status information are displayed.

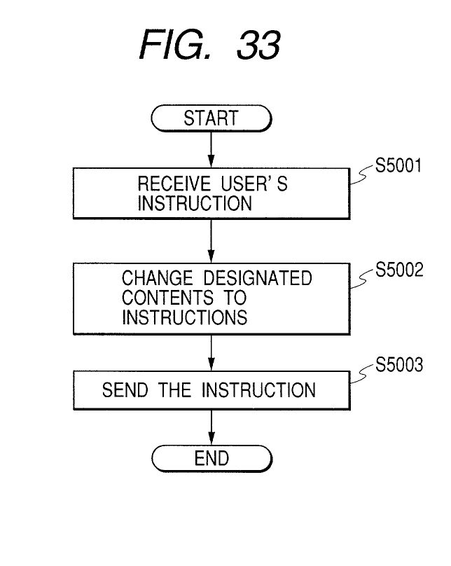

FIG. 33 is a flow chart for explaining an operation of the program for manipulating the digital camera 700 from the personal information terminal 200, according to the sixth embodiment of the present invention. This program is called up from step S1400 depicted in FIG. 6 in response to instructions from the user, and the program achieves a function of producing appropriate instructions for the digital camera 700 through the communications device.

First, at step S5001 the user's instructions are received. Specifically, the instructions are made through the GUI in the upper portion of the screen in the example display of FIG. 31 discussed above. Next, at step S5002 the content designated by the user is converted into appropriate instructions which can be processed by the digital camera 700. Specifically, there is a conversion table inside the personal information terminal 200 for making this conversion into processing commands suited to that particular digital camera 700 type, and the conversion into the appropriate commands is made making reference to this table. For example, in the case when the user pushes the shutter button displayed on the screen, this is converted into a “capture command” adapted for the digital camera 700. Then, at step S5003 the converted command is sent to the digital camera 700 through the communications device.

Here, when the remote control of the sixth embodiment of the present embodiment is used the processing on the side of the digital camera 700 is comprised basically of a process of receiving the command from the remote controller and executing the various contents of the command in order. However, in the case when there is no command from the remote control, the process sends the digital camera status information and the image data obtained from the image capturing elements to the remote control side after a predetermined duration of time elapses (ex, after 5 seconds). At this time the image data is compressed according to an appropriate compression format and then sent.

Note that the digital camera status information and the image data obtained from the image capturing elements are only sent in the case when either the image data or the digital camera status information have been changed, and if there has not been a change then it is conceivable that this transmission would be stopped.

As explained above, the personal information terminal according to the sixth embodiment of the present invention similar to that of the first embodiment in that it is a compact terminal but can provide a large screen, and in particular, it is capable of achieving an effect such that it becomes possible to provide in an appropriate fashion to the user information provided by external interfaces which have become capable of massive volume such as “massive amounts of complex information available with internet information services”, or from “high quality image data available with images using high-definition digital photographs or CGI, for example, and in addition, by using the personal information terminal of the present invention as a remote control for a digital camera an effect is achieved such that it becomes possible to maintain the compact exterior size that is desired in a remote control while delivering to the remote control operator an image of a captured subject obtained from the image capturing elements of a digital camera.

In addition, it goes without saying that even in a case when a recording medium storing the program code of the software for achieving the functions of each of the Embodiments described above is provided to a system or a device, and a computer (or CPU or MPU) of that system or device reads and executes this program code stored in the recording medium, this still achieves the present invention.

In such a case, it is the program code which is read out from the recording medium which can achieves the functions of each of the above Embodiments, and it is the recording medium storing that program code which comprises the present invention.

For the recording medium for providing the program code it is possible to use, for example, a floppy disk, a hard disk, an optical disk, an optical magnetic disk, a CD-ROM, a CD-R, magnetic tape, a non-volatile memory card, a ROM, or the like.

Further, it goes without saying that the present invention includes not only the case in which the functions of each of the Embodiments discussed above are achieved by the computer executing the program code which has been read out, but it also includes cases in which the functions of each of the embodiments discussed above are achieved by a part or all of the actual processing is performed the OS or the like running on the computer based on the instructions in the program code.

Additionally, it goes without saying that the present invention also includes a case in which the program code which has been read out from the recoding medium is written to the memory of the function expansion board in the computer or the function expansion unit connected to the computer, and after that, the CPU or such provided to that function expansion board or function expansion unit performs a part of or all of the actual processing, and the functions of each of the embodiments discussed above are achieved by the processing.

What is claimed is:

1. A personal information terminal comprising:
a data display means including an enlarging optical system;
an input means for receiving instructions from a user;
a radio communications means for connecting to a network; and
a control means for obtaining information from the network through the radio means and displaying the information on the data display means, based on instructions from the input means.

2. A personal information terminal according to claim 1, wherein the control means limits the electrical power supply to the data display means to an amount which is less than an amount at a normal time while the control means is obtaining the information from the network through the radio means.

3. A personal information terminal according to claim 1, wherein the data display means is an ocular-type data device comprising of a prism, a liquid crystal display device and an illumination device.

4. A personal information terminal according to claim 3, wherein the control means cuts off the electrical power supply to the illumination device while the control means is obtaining the information from the network through the radio means.

5. A personal information terminal according to claim 3, wherein the control means turns the liquid crystal display device onto a low energy consumption mode while the control means is obtaining the information from the network through the radio means.

6. A personal information terminal according to claim 1, wherein the input means is a push button switch.

7. A personal information terminal comprising:
an ocular-type data display means arranged within a frame of a window and having an enlarging optical system;
an input means for receiving instructions from a user;
a radio communications means for connecting to a network;
a control means for obtaining information from the network through the radio means and making the information be displayed on the data display means, based on instructions from the input means; and
a notifying means for providing a notification to a user at least as to whether the control means is in a state of obtaining information from the network through the radio means or not the notifying means being arranged outside the frame of the window.

8. A personal information terminal according to claim 7, wherein the notification means makes the notification visually.

9. A personal information terminal according to claim 8, wherein the notification means comprises a light emitting diode capable of emitting light of a plurality of colors.

10. A personal information terminal according to claim 7, wherein the notification means makes the notification auditorily.

11. A personal information terminal according to claim 10, wherein the notification means comprises a speaker.

12. A personal information terminal according to claim 7, wherein the notification means provides notification to the user as to whether the control means is in a state of obtaining information from the network through the radio means, or whether it is in a state of displaying the obtained information on the data display means.

13. A personal information terminal according to claim 12, wherein the notification means further provides notifications to the user as to whether the radio means is in a state of having ended the network connection normally, or whether the radio means is in a state of having ended the network connection abnormally.

14. A personal information terminal according to claim 7, wherein the data display means is comprised of at least a liquid crystal display device and a prism having a substantially triangular column shape; and
wherein the notification means is located near the bottom surface of the substantially triangular column of the prism.

15. A personal information terminal according to claim 1, wherein the input means is comprised of a moving means for moving a cursor position on a display screen of the data display means; and
wherein a starting means for starting a process corresponding to information on the display screen where the cursor is located.

16. A personal information terminal according to claim 15, wherein the moving means is a means for converting manipulation instructions from the user into vector values on a two-dimensional plane surface, and the starting means is a push button switch.

17. A personal information terminal according to claim 15, wherein the data display means is lodged within a frame of a display window provided to a housing of the personal information terminal, wherein the moving means is arranged on a side of the personal information terminal housing that the display window frame is located on, and wherein the starting means is arranged on a side opposite from the side that the display window frame is located on.

18. A personal information terminal according to claim 17, wherein a curved groove is provided to the side of the personal information terminal housing that is opposite from the side that the display window frame is located on, and the starting means is arranged in this groove.

19. A personal information terminal according to claim 15, wherein the data display means is arranged within the frame of the window provided to the housing of the personal information terminal, wherein the starting means is arranged on the side of the personal information terminal housing that the display window frame is located on, and wherein the moving means is arranged on the side opposite from the side that the display window frame is located on.

20. A personal information terminal according to claim 19, wherein a curved groove is provided to the side of the personal information terminal housing that is opposite from the side that the display window frame is located on, and the moving means is arranged in this groove.

21. A personal information terminal according to claim 1, wherein the data display means is arranged within a frame of a display window provided to a housing of the personal information terminal, and the input means is provided on the personal information terminal housing, and a surface of the display window and a surface of the housing where the input means is arranged are parallel.

22. A personal information terminal according to claim 21, wherein a predetermined distance exists between the housing surface where the display window is provided and the housing surface where the input means is provided.

23. A personal information terminal according to claim 22, wherein the predetermined distance is at least the size of a thumb.

24. A personal information terminal according to claim 1, wherein the data display means is arranged within a frame of a display window provided to a housing of the personal information terminal, and an area around the display window frame is black.

25. A personal information terminal according to claim 7, wherein the window frame is provided to a housing of the personal information terminal, and the notification means is arranged either on a surface of the housing where the window frame is provided, or on a surface of the housing that is perpendicular to the housing surface where the window is provided.

26. An energy-consumption reduction method to be applied in a personal information terminal having a data display means including an enlarging optical system, an input means for receiving instructions from a user and a radio communications means for connecting to a network, the method comprising:
an information obtaining step of obtaining information from the network through the radio means based on instructions from the input means;
a display step of displaying the information obtained in the information obtaining step on the data display means; and
a limiting step of limiting an amount of the electrical power supply to the data display means while the information is being obtained from the network through the radio means at the information obtaining step, the amount being less than an amount at a normal time.

27. An energy-consumption reduction method according to claim 26, wherein the data display means is comprised of a prism, a liquid crystal display device and an illumination device; and
wherein the electrical power supply to the illumination means is cut off in the limiting step while the information is being obtained from the network through the radio means at the information obtaining step.

28. An energy-consumption reduction method according to claim 26, wherein the data display means is comprised of a prism, a liquid crystal display device and an illumination device; and
wherein the liquid crystal display is turned onto a low energy consumption mode in the limiting step while the information is being obtained from the network through the radio means at the information obtaining step.

29. A status notification method to be applied in a personal information terminal having an ocular-type data display means arranged within a frame of a window and having an enlarging optical system, an input means for receiving instructions from a user, a radio communications means for connecting to a network and a notifying means arranged outside the frame of the window, comprising of:
an information obtaining step obtaining information from the network through the radio means based on instructions from the input means;
a display step of displaying the information obtained in the obtaining step on the data display means; and
a notifying step of providing a notification to a user at least as to whether information is being obtained from the network through the radio means or not by means of a notification means.

30. A status notification method according to claim 29, wherein in the notification step the notification means provides notification to the user as to whether the information is being obtained from the network through the radio means at the information obtaining step, or whether the information is being displayed on the data display means at the display step.

31. A status notification method according to claim 30, wherein, in the notification step, the notification means further provides notification to the user as to whether the radio means is in a state of having ended the network connection normally, or whether the radio means is in a state of having ended the network connection abnormally.

32. A computer readable recording medium storing as a program an energy-consumption reduction method to be applied in a personal information terminal having a data display means equipped with an enlarging optical system, an input means for receiving instructions from a user and a radio communications means for connecting to a network, the energy-consumption reduction method comprising:
an information obtaining step of obtaining information from the network through the radio means based on instructions from the input means;
a display step of displaying the information obtained in the information obtaining step on the data display means; and
a limiting step of limiting an amount of the electrical power supply to the data display means while the information is being obtained from the network through the radio means at the information obtaining step, the amount being less than an amount at a normal time.

33. A recording medium according to claim 32, wherein the data display means is comprised of a prism, a liquid crystal display device and an illumination device; and
wherein the electrical power supply to the illumination means is cut off in the limiting step while the information is being obtained from the network through the radio means at the information obtaining step.

34. An recording medium according to claim 32, wherein the data display means is comprised of a prism, a liquid crystal display device and an illumination device; and
wherein the liquid crystal display device is turned onto a low energy consumption mode in the limiting step while the information is being obtained from the network through the radio means at the information obtaining step.

35. A computer readable recording medium storing as a program a status notification method to be applied in a personal information terminal having an ocular-type data display means arranged within a frame of a window and having an enlarging optical system, an input means for receiving instructions from a user, a radio communications means for connecting to a network and a notifying means arranged outside the frame of the window, the status notification method comprising:
an information obtaining step of obtaining information from the network through the radio means based on instructions from the input means;
a display step of displaying the information obtained in the information obtaining step on the data display means; and
a notifying step of providing a notification to a user at least as to whether the information is being obtained from the network through the radio means or not by means of a notification means.

36. A recording medium according to claim 35, wherein in the notification step the notification means provides notification to the user as to whether the information is being obtained from the network through the radio means at the information obtaining step, or whether the information is being displayed on the data display means at the display step.

37. A recording medium according to claim 36, wherein in the notification step the notification means further provides notification to the user as to whether the radio means is in a state of having ended the network connection normally, or whether the radio means is in a state of having ended the network connection abnormally.
